(19) United States
(12) Patent Application Publication
(10) Pub. No.: US 2003/0140159 A1
(43) Pub. Date: Jul. 24, 2003

(54) Method and system for transmitting and/or retrieving real-time video and audio information over performance-limited transmission systems

(76) Inventors: Roy H. Campbell, Champaign, IL (US); See-Mong Tan, Champaign, IL (US); Dong Xie, Urbana, IL (US); Zhigang Chen, Savoy, IL (US)

Correspondence Address: L. Scott Paynter, Woodard Emhardt Naughton Moriarty & McNett, Bank One/Center Tower, 111 Monument Circle, Indianapolis, IN, 46204, US

(21) Appl. No.: 10/251,910

(22) Filed: Feb. 18, 2003

Related U.S. Application Data
(63) Continuation of application No. 09/670,604, filed on Sep. 26, 2000, now abandoned.
Application No. 09/670,604 is a continuation of application No. 09/091,251, filed on Jul. 21, 1998, now abandoned.
Application No. 09/091,251 is a continuation of application No. PCT/US96/19226, filed on Dec. 2, 1996.
(60) Provisional application No. 60/008,531, filed on Dec. 12, 1995.

(51) Int. Cl. G06F 15/16

(52) U.S. Cl. 709/231; 709/203

(57) ABSTRACT

Among the embodiments of the present invention is a system for transmitting real-time continuous media information over a network. This continuous media information includes at least video or audio. A communication channel connects a server and client for communicating the continuous media information from the server to the client. This continuous media information is reproduced at least in part at the client during the communication from the server to the client of such information.

### FIELD OF THE INVENTION

The present invention relates to a method of and system for transmitting and/or retrieving real-time video and audio information. The inventive method compensates for congested conditions and other performance limitations in a transmission system over which the video information is being transmitted. More particularly, the invention relates to a method of transmitting and/or retrieving real-time video and audio information over the Internet, specifically the World Wide Web.

### BACKGROUND OF THE INVENTION

“Surfing the Web” has entered the common vocabulary relatively recently. Individuals and businesses have come to use the Internet both for electronic mail (e-mail) and for access to information, commonly over-the World Wide Web (WWW, or the Web). As modem speeds have increased, so has Web traffic.

Web browsers, such as National Computer Security Association (NCSA) Mosaic, allow users to access and retrieve documents on the Internet. These documents most often are written in a language called HyperText Markup Language (HTML). Traditional information systems design for World Wide Web clients and servers has concentrated on document retrieval and the structuring of document-based information, for example, through hierarchical menu systems as are used in Gopher, or links in hypertext as in HTML.

Current information systems architecture on the Web has been driven by the static nature of document-based information. This architecture is reflected in the use of the file transfer mode of document retrieval and the use of stream-based protocols, such as TCP. However, full file transfer and TCP are unsuitable for continuous media, such as video and audio, for reasons which will be discussed in greater detail below.

The easy-to-use, point-and-click user interfaces of WWW browsers, first popularized by Mosaic, have been the key to the widespread adoption of HTML and the World Wide Web by the entire Internet community. Although traditional WWW browsers perform commendably in the static information spaces of HTML documents, they are ill-suited for handling continuous media, such as real time audio and video.

Earlier Web browsers, such as Mosaic, required a user to wait until a document had been retrieved completely before displaying the document on the screen. Even at the faster transfer speeds which have been become possible in recent years, the delay between retrieval request and display has been frustrating for many users. Particularly in view of the astronomical increase in Internet traffic, during especially busy times, congestion over the Internet has negated at least some of the speed advantages users have obtained by getting faster modems.

Video and audio files tend to be much larger than document files in many instances. As a result, the delay involved in waiting for an entire file to download before it is displayed is even greater for video and audio files than for document files. Again, during busy times, Internet congestion would make the delays intolerable. Even in networks which are separate from the Internet, transmission of sizable video and audio files can result in long waits for file transfer prior to display.

Multimedia browsers such as Mosaic have been excellent vehicles for browsing information spaces on the Internet that are made up of static data sets. Proof of this is seen in the phenomenal growth of the Web. However, attempts at the inclusion of video and audio in the current generation of multimedia browsers have been limited to transfer of pre-recorded and canned sequences that are retrieved as full files. While the file transfer paradigm is adequate in the arena of traditional information retrieval and navigation, it becomes cumbersome for real time data. The transfer times for video and audio files can be very large. Video and audio files now on the Web take minutes to hours to retrieve, thus severely limiting the inclusion of video and audio in current Web pages, because the latency required before playback begins can be unacceptably long. The file transfer method of browsing also assumes a fairly static and unchanging data set for which a single uni-directional transfer is adequate for browsing some piece of information. Real time sessions such as videoconferences, on the other hand, are not static. Sessions happen in real time and come and go over the course of minutes to days.

The Hypertext Transfer Protocol (HTTP) is the transfer protocol used between Web clients and servers for hypertext document service. The HTTP uses TCP as the primary protocol for reliable document transfer. TCP is unsuitable for real time audio and video for several reasons.

First, TCP imposes its own flow control and windowing schemes on the data stream. These mechanisms effectively destroy the temporal relations shared between video frames and audio packets.

Second, unlike static documents and text files, in which data loss can result in irretrievable corruption of the files, reliable message delivery is not required for video and audio. Video and audio streams can tolerate frame losses. Losses are seldom fatal, although of course they can be detrimental to picture and sound quality. TCP retransmission, a technique which facilitates reliable document and text transfer, causes further jitter and skew internally between frames and externally between associated video and audio streams.

Progress has been made in facilitating transfer of static, document-based information. Web browsers such as Netscape(tm) have enabled documents to be displayed as they are retrieved, so that the user does not have to wait for the entire document to be retrieved prior to display. However, the TCP protocol which is used to transfer documents over the Web is not conducive to real-time display of video and audio information. Transfers of such information over TCP can be herky-jerky, intermittent, or delayed.

Several products have attempted to combine real time video with Web browsers like Netscape(tm) by invoking external player programs. This approach is clumsy, using standard TCP/IP Internet protocols for video retrieval. Also, external viewers have not fully integrated video into the Web browser.

Several commercial products, such as VDOlive and Streamworks, allow users to retrieve and view video and audio in real time over the World Wide Web. However, these products use either vanilla TCP or UDP for network transmission. Without resource reservation protocols in use within the Internet, TCP or UDP alone do not suffice for continuous media. Adaptable and media-specific protocols are required. Video and audio can also only be viewed in a primitive, linear, VCR-mode. The issues of content preparation and reuse are also not addressed.

Sun Microsystem's HotJava product enables the inclusion of animated multimedia in a Web browser. HotJava allows the browser to download executable scripts written in the Java programming language. The execution of the script at the client end enables the animation of graphic widgets within a Web page. However, HotJava does not employ an adaptive algorithm that is customized for video transfer over the WWW.

While the foregoing problems of video and audio transmission over networks have been discussed in the context of the Internet, the problems are by no means limited to the Internet. Any network which experiences congestion, or has computers connected to it which experience excessive load, can encounter the same difficulties when transferring video and audio files. Whether the network is a local area network (LAN), a metropolitan area network (MAN), or a wide area network (WAN), transmission congestion and processor load limitations can pose severe difficulties for video and audio transmission using current protocols.

In view of the foregoing, it would be desirable to reduce the delays in display of video and audio files over networks, including LANs, MANs, WANs, and/or the Internet.

It also would be desirable to provide a system which enables real-time display of video and audio files over LANs, MANs, WANs, and/or the Internet.

Moreover, multiple views of the same video and audio should be supported. Parts of a video and audio clip, or the whole clip, can be used for different purposes. A single physical copy of a large video and audio document should support different access patterns and uses. All or part of the original continuous media document should be contained within other documents without copying. Content preparation would be simplified, and the flexible reuse of video content would be efficiently supported.

### SUMMARY OF THE INVENTION

The inventors have concluded that to truly support video and audio in the WWW, one requires:

1) the transmission of video and audio on-demand, and in real time; and

2) new protocols for real time data.

The inventors' research has resulted in a technique that the inventors call Vosaic, short for Video Mosaic, a tool that extends the architecture of vanilla NCSA Mosaic to encompass the dynamic, real time information space of video and audio. Vosaic incorporates real time video and audio into standard Web pages and the video is displayed in place. Video and audio transfers occur in real time; as a result, there is no retrieval latency. The user accesses real time sessions with the familiar “follow-the-link” point and click method that has become well-known in Web browsing. Mosaic was considered to be a preferred software platform for the inventors' work at the time the invention was made because it is a widely available tool for which the source code is available. However, the algorithms which the inventors have developed are well-suited for use with numerous Internet applications, including Netscape(tm), Internet Explorer(tm), HotJava(tm), and a Java-based collaborative work environment called Habanero. Vosaic also is functional as a stand-alone video browser. Within Netscape(tm), Vosaic can work as a plug-in.

In order to incorporate video and audio into the Web, the inventors have extended the architecture of the Web to provide video enhancement. Vosaic is a vehicle for exploring the integration of video with hypertext documents, allowing one to embed video links in hypertext. In Vosaic, sessions on the Multicast Backbone (Mbone) can be specified using a variant of the Universal Resource Locator (URL) syntax. Vosaic supports not only the navigation of the Mbone's information space, but also real time retrieval of data from arbitrary video servers. Vosaic supports the streaming and display of real time video, video icons and audio within a WWW hypertext document display. The Vosaic client adapts to the received video rate by discarding frames that have missed their arrival deadline. Early frames are buffered, minimizing playback jitter. Periodic resynchronization adjusts the playback to accommodate network congestion. The result is real time playback of video data streams.

Present day httpd (“d” stands for “daemon”) servers exclusively use the TCP protocol for transfers of all document types. Real time video and audio data can be effectively served over the present day Internet and other networks with the proper choice of transmission protocols.

In accordance with the invention, the server uses an augmented Real Time Protocol (RTP) called Video Datagram Protocol (VDP), with built-in fault tolerance for video transmission. VDP is described in greater detail below. Feedback within VDP from the client allows the server to control the video frame rate in response to client CPU load or network congestion. The server also dynamically changes transfer protocols, adapting to the request stream. The inventors have identified a forty-four-fold increase in the received video frame rate (0.2 frames per second (fps) to 9 fps) with VDP in lieu of TCP, with a commensurate improvement in observed video quality. These results are described in greater detail below.

On demand, real time video and audio solves the problem of playback latency. In Vosaic, the video or audio is streamed across the network from the server to the client in response to a client request for a Web page containing embedded videos. The client plays the incoming multimedia stream in real time as the data is received in real time.

However, the real time transfer of multimedia data streams introduces new problems of maintaining adequate playback quality in the face of network congestion and client load. In particular, as the WWW is based on the Internet, resource reservation to guarantee bandwidth, delay or jitter is not possible. The delivery of Internet protocol (IP) packets across the international Internet is typically best effort, and subject to network variability outside the control of any video server or client.

A number of the network congestion and client load issues that arise on the Internet also pertain to LANs, MANs, and WANs. Therefore, the technique of the invention could well be applicable to these other network types. However, the focus of the inventors' work, particularly so far as the preferred embodiment is concerned, has been in an Internet application.

In terms of supporting real time video on the Web, inter-frame jitter greatly affects video playback quality across the network. (For purposes of the present discussion, jitter is taken to be the variance in inter-arrival time between subsequent frames of a video stream.) A high degree of jitter typically causes the video playback to appear “jerky”. In addition, network congestion may cause frame delays or losses. Transient load at the client side may prevent the client from handling the full frame rate of the video.

In order to accomplish support for real time video on busy networks, and in particular on the Web, the inventors created a specialized real time transfer protocol for handling video across the Internet. The inventors have determined that this protocol successfully handles real time Internet video by minimizing jitter and incorporating dynamic adaptation to the client CPU load and network congestion.

In accordance with another aspect of the invention, continuous media organization, storage and retrieval are provided. In the present invention, continuous media consist of video and audio information. There are several classes of so-called meta-information which describe various aspects of the continuous media itself. This meta-information includes the inherent properties of the media, hierarchical information, semantic description, as well as annotations that provide support for hierarchical access, browsing, searching, and dynamic composition of the continuous media.

To accomplish these and other objects, the invention provides a method and a system for real time transmission of data on a network which links a plurality of computers. The method and system involve at least two, and typically a larger number of networked computers, wherein, during real time transmission of data, parameters affecting the potential rate of data transmission in the system (e.g. network and/or performance) are monitored periodically, and the information derived from the feedback used to moderate the rate of real-time data transmission on the network.

According to one embodiment, first and second computers are provided, the second computer having a user output device connected to it. To establish real-time transmission, the first and second computers first establish communication with each other. The computers determine transmission performance between them, and also communicate processing performance (e.g. processor load) of the second computer. The first computer transmits data to the second computer for output on the user output device in real time. The rate of transmitting data is adjusted as a function of network performance and/or processor performance.

In accordance with a further preferred embodiment, the first computer has a resident program which provides for real time transmission of data, and which determines network performance. The second computer has a resident program which enables receipt of data and routing of that data to the user output device in real time. The second computer's program may condition the data further, and also may communicate processor performance information to the first computer. The program in the first computer may degrade or upgrade real time data transmission rates to the second computer based on the network and/or processor performance information received.

In accordance with a still further preferred embodiment, the first and second computers communicate with each other over two channels, one channel passing control information between the two computers, and the other channel passing data for real time output, and also feedback information, such as network and/or processor performance information. The integrity of the second channel need not be as robust as that of the first channel, in view of the dynamic allocation ability of the real time transmission.

Communication between the first and second computers may involve static data, such as for document transmission, as well as continuous media, such as for video and audio transmission. Preferably, the inventive method and system are applied to handling of continuous media.

In normal, larger applications, the first computer, or server, will have a number of computers, or clients, with which the server will communicate, using the dual-channel, feedback technique of the invention.

### BRIEF DESCRIPTION OF THE DRAWINGS

The foregoing and other objects and features of the invention will become apparent from the following detailed description with reference to the accompanying drawings, in which:

FIG. 1 shows a four-item video menu as part of the invention;

FIG. 2 is a diagram of the internal structure of the invention;

FIG. 3 shows a video control panel in accordance with the invention;

FIG. 4 shows structure of a server configured in accordance with the invention;

FIG. 5 depicts the connection between a server and a client in accordance with the invention;

FIG. 6 depicts retransmission and size of a buffer queue;

FIG. 7 depicts a transmission queue;

FIG. 8 is a flow graph for moderating transmission flow;

FIGS. 9-13 are flow charts depicting operation of the invention, and in particular, operation of a server and its associated clients;

FIG. 14 shows the hardware environment of one embodiment of the present invention;

FIGS. 15a-15g show interface screens which demonstrate the invention;

FIG. 16 is a graph of a frame rate adaptation in accordance with the invention;

FIG. 17 depicts structure of continuous media;

FIG. 18 depicts hierarchical organization and indexing of an example of continuous media;

FIG. 19 contains a list of keyword descriptions for providing links to continuous media;

FIG. 20 shows a display screen of the invention side by side with the hierarchical architecture of the continuous media to be displayed;

FIG. 21 is a screen displaying the results of a key word search;

FIG. 22 is a screen displaying an example of hyperlinks embedded in video data;

FIG. 23 depicts dynamic composition of video streams; and

FIG. 24 depicts interpolation of hyperlinks in video streams.

### DETAILED DESCRIPTION OF PREFERRED EMBODIMENTS

As was mentioned earlier, Vosaic is based on NCSA Mosaic. Mosaic concentrates on HTML documents. While all media types are treated as documents, each media type is handled differently. Text and inlined images are displayed in place. Other media types, such as video and audio files, or special file formats (e.g., Postscript(tm)) are handled externally by invoking other programs. In Mosaic, documents are not displayed until fully available. The Mosaic client keeps the retrieved document in temporary storage until all of the document has been fetched. The sequential relationship between transferring and processing of documents makes the browsing of large video/audio documents and real time video/audio sources problematic. Transferring such documents require long delay times and large client side storage space. This makes real time playback impossible.

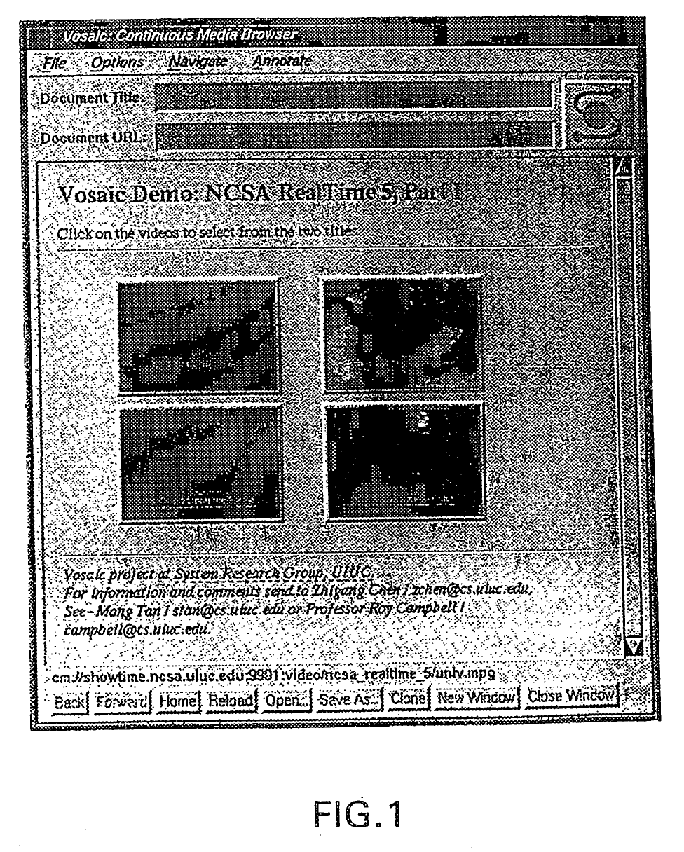

Real time video and audio convey more information if directly incorporated into the display of a hypertext document. For example, the inventors have implemented real time video menus and video icons as an extension of HTML in Vosaic. FIG. 1 depicts a typical four-item video menu which can be constructed using Vosaic. Video menus present the user with several choices. Each choice is in the form of a moving video. One may, for example, click on a video menu item to follow the link, and watch the clip in full size. Video icons show a video in an small, unobtrusive icon-sized rectangle within the HTML document. Embedded real time video within WWW documents greatly enhances the look and feel of a Vosaic page. Video menu items convey more information about the choices available than simple textual descriptions or static images.

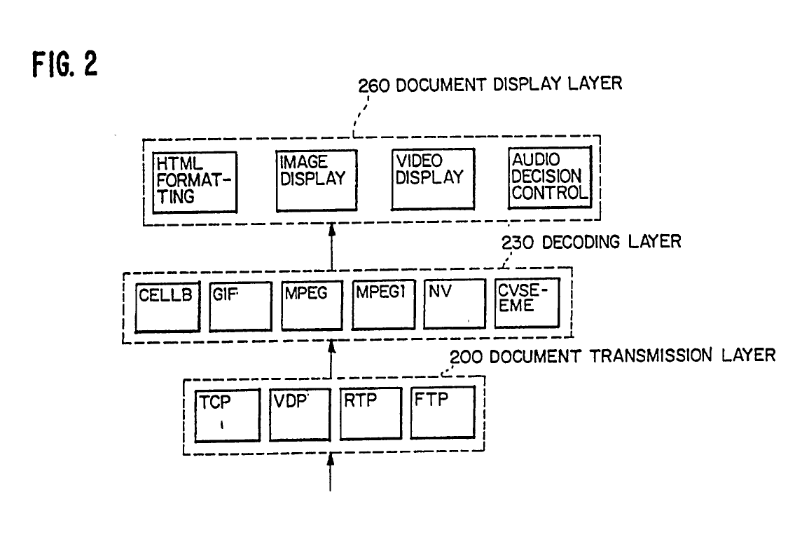

Looking more closely at the internal structure of Vosaic, HTML documents with video and audio integrated therein are characterized by a variety of data transmission protocols, data decoding formats, and device control mechanisms (e.g., graphical display, audio device control, and video board control). Vosaic has a layered structure to meet these requirements. The layers, which are depicted in FIG. 2, are document transmission layer 200, document decoding layer 230, and document display layer 260.

A document data stream flows through these three layers by using different components from different layers. The composition of components along the data path of a retrieved document occurs at run-time according to document meta-information returned by an extended HTTP server.

As discussed earlier, TCP is only suitable for static document transfers, such as text and image transfers. Real time playback of video and audio requires other protocols. The current implementation in the Vosaic document transmission layer 200 includes TCP, VDP and RTP. Vosaic is configured to have TCP support for text and image transmission. Real time playback of real time video and audio uses VDP. RTP is the protocol used by most Mbone conferencing transmissions. A fourth possible protocol is for interactive communication (used for virtual reality, video games and interactive distance learning) between the web client and server. The decoding formats currently implemented in document decoding layer 230 include:

For images: GIF and JPEG

For video: MPEG1, NV, CUSEEME, and Sun CELLB

For audio: AIFF and MPEG1

MPEG1 includes support for audio embedded in the video stream. The display layer 260 includes traditional HTML formatting and inline image display. The display has been extended to incorporate real time video display and audio device control.

Standard URL specifications include FTP, HTTP, Wide Area Information System (WAIS), and others, covering most of the currently existing document retrieval protocols. However, access protocols for video and audio conferences on the Mbone are neither defined nor supported. In accordance with the invention, the standard URL specification and HTML have been extended to accommodate real time continuous media transmission. The extended URL specification supports Mbone transmission protocols using the mbone keyword as a URL scheme, and on-demand continuous media protocols using cm (for “continuous media”) as the URL scheme. The format of the URL specifications for the Mbone and continuous real time are as follows:

mbone://address:port:ttl:format

cm://address:port:format/filepath

Examples are given below:

mbone://224.2.252.51:4739:127:nv

cm://showtime.ncsa.uiuc.edu:8080:mpegvideo/puffer.mpg

cm://showtime.ncsa.uiuc.edu:8080:mpegaudio/puffer.mp2

The first URL encodes an Mbone transmission on the address 224.2.252.51, on port 4739, with a time to live (TTL) factor of 127, using nv (for “network video”) video transmission format. The second and third URLs encode continuous media transmissions of MPEG video and audio respectively.

Incorporating inline video and audio in HTML necessitates the addition of two more constructs to the HTML syntax. The additions follow the syntax of inline images closely. Inlined video and audio segments are specified as follows:

<video src=“address:port/filepath option=cyclic|control”>

<audio src=“address:port/filepath option=cyclic|control”>

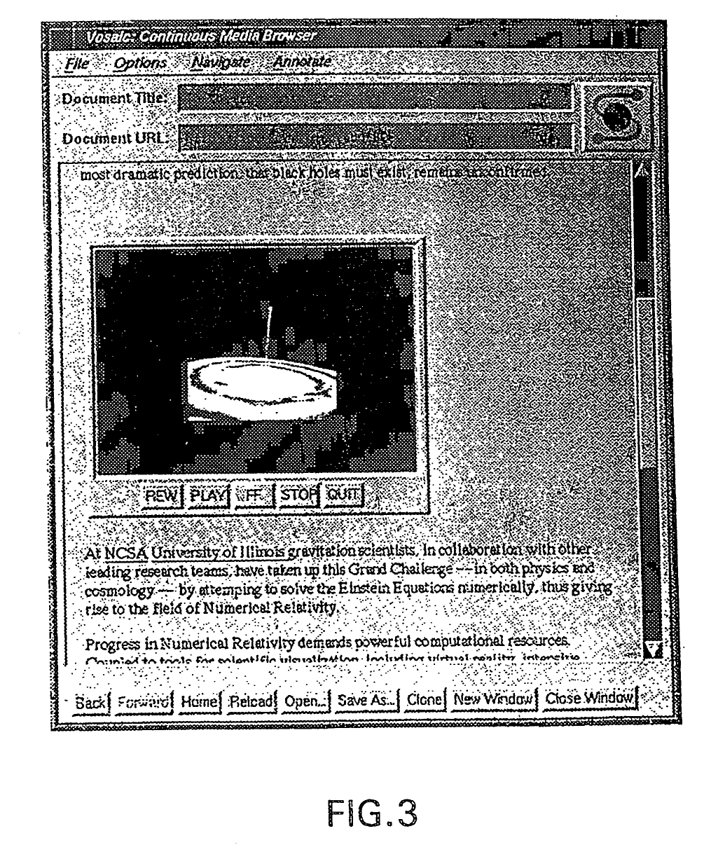

The syntax for both video and audio is made up of a src part and an options part. Src specifies the server information including the address and port number. Options specifies how the media is to be displayed. Two options are possible: control or cyclic. The control display option pops up a window with a control panel and the first frame of the video is displayed, with further playback controlled by the user. FIG. 3 shows a page with a video control panel, as will be described.

The cyclic display option displays the video or audio clip in a loop. The video stream may be cached in local storage to avoid further network traffic after the first round of display. This is feasible when the size of video or audio clip is small. If the segment is too large to be stored locally at the client end, the client may also request the source to send the clip repeatedly. Cyclic video clips are useful for constructing video menus and video icons.

If the control keyword is given, a control panel is presented to the user. A control interface, also shown in FIG. 3, allows users to browse and control video clips. The following user control buttons are provided:

Rewind: Play the video backwards at a fast speed.

Play: Start to play the video.

Fast Forward: Play the video at a faster speed. In accordance with the preferred embodiment, this is implemented by dropping frames at the server site. Determination of circumstances surrounding frame dropping, and implementation of frame dropping techniques, are discussed in greater detail below.

Stop: Ends the playing of the video.

Quit: Terminates playback. When the user presses “Play” again, the video is restarted from the beginning.

Real time video and audio use VDP as a transfer protocol over one channel between the client and the server. Control information exchange uses a TCP connection between the client and server. Thus, there are two channels of communication between the client and the server, as will be described.

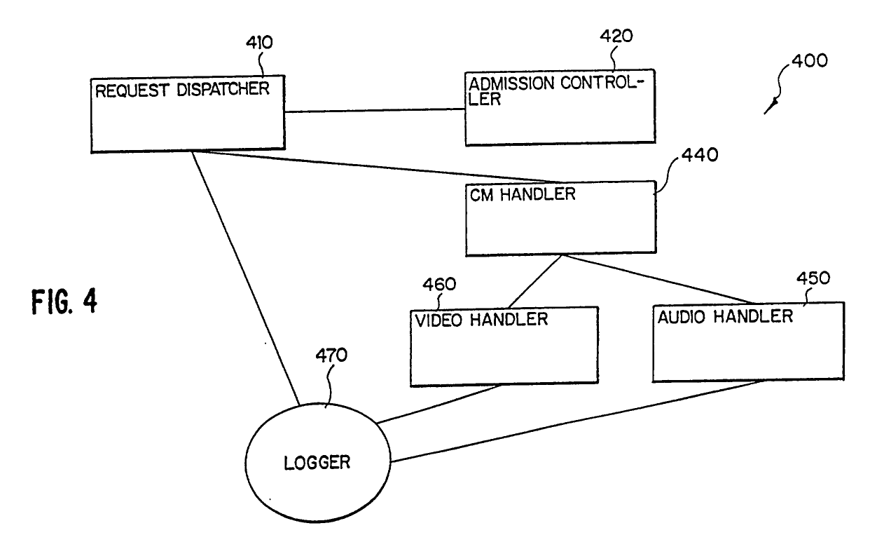

Vosaic works in conjunction with a server 400, a preferred configuration of which is shown in FIG. 4. The server 400 uses the same set of transmission protocols as does Vosaic, and is extended to handle video transmission. Video and audio are transmitted with VDP. Frames are transmitted at the originally recorded frame rate of the video. The server uses a feed forward and feedback scheme to detect network congestion and automatically delete frames from the stream in response to congestion.

In previously preferred embodiments, the server 400 handled HTTP as well as continuous media However, HTTP applications can be handled outside of Vosaic, so inclusion of HTTP, and of an HTTP handler no longer is essential to the implementation. Also, among continuous media formats, the inventors had experimented with MPEG, but since have confirmed that Vosaic works well with numerous video and audio standards, including (but by no means limited to) H.263, GSM, and G.723.

The main components of the server 400, shown in FIG. 4, are a main request dispatcher 410, an admission controller 420, continuous media (cm) handler 440, audio and video handlers 450, 460, and a server logger 470.

In operation, the main request dispatcher 410 receives requests from clients, and passes them to the admission controller 420. The admission controller 420 then determines or estimates the requirements of the current request; these requirements may include network bandwidth and CPU load. Based on knowledge of current conditions, the controller 420 then makes a decision on whether the current request should be serviced.

Traditional HTTP servers can manage without admission control because document sizes are small, and request streams are bursty. Requests simply are queued before service, and most documents can be handled quickly. In contrast, with continuous media transmissions in a video server, file sizes are large, and real time data streams have stringent time constraints. The server must ensure that it has enough network bandwidth and processing power to maintain service qualities for current requests. The criteria used to evaluate requests may be based on the requested bandwidth, server available bandwidth, and system CPU load.

In accordance with a preferred embodiment of the invention, the system limits the number of concurrent streams to a fixed number. However, the admission control policy is flexible; a more sophisticated policy is within the inventors' contemplation, and in this context would be within the abilities of the ordinarily skilled artisan.

Once the system grants the current request, the main request dispatcher 410 hands the request to cm handler 440, which then hands the appropriate part of the request to the corresponding audio or video handler 450, 460. While the video and audio handlers use VDP, as described below, in accordance with the invention, the server design is flexible enough to incorporate more protocols.

The server logger 470 is responsible for recording the request and transmission statistics. Based on studies of access patterns of the current Web servers, it is expected that the access patterns for a video enhanced Web server will be substantially different from those of traditional WWW servers that support mainly text and static images.

The server logger 470 records the statistics for the transmission of continuous media in order to better understand the behavior of requests for continuous media. The statistics include the network usage and processor usage of each request, the quality of service data such as frame rate, frame drop rate, and jitter. The data will guide the design of future busy Internet video servers. These statistics are also important for analyzing the impact of continuous media on operating systems and the network.

Video Datagram Protocol (VDP)

Looking now at the protocol for transmitting video in real time, the inventive video datagram protocol, or VDP, is an augmented real time datagram protocol developed to handle video and audio over the Web. VDP design is based on making efficient use of the available network bandwidth and CPU capacity for video processing. VDP differs from RTP in that VDP takes advantage of the point-to-point connection between Web server and Web client. The server end of VDP receives feedback from the client and adapts to the network condition between client and server and the client CPU load. VDP uses an adaptation algorithm to find the optimal transfer bandwidth. A demand resend algorithm handles frame losses. VDP differs from Cyclic-UDP in that it resends frames upon request instead of sending frames repeatedly, hence preserving network bandwidth, and avoiding making network congestion worse.

In accordance with the invention, the video also contains embedded links to other objects on the Web. Users can click on objects in the video stream without halting the video. The inventive Vosaic Web browser will follow the embedded hyperlink in the video. This promotes video to first class status within the World Wide Web. Hypervideo streams can now organize information in the World Wide Web in the same way hypertext improves plain text.

VDP is a point-to-point protocol between a server program which is the source of the video and audio data, and a client program which allows the playback of the received video or audio data. VDP is designed to transmit video in Internet environments. There are three problems the algorithm must overcome:

bandwidth variance in the network,

packet loss in the network, and

the variable bit rate (VBR) nature of some compressed video formats.

The amount of available bandwidth may be less than that required by the complete video stream, due to fluctuating bandwidth in the network, or due to high bandwidth stretches of VBR video. Packet loss may also adversely affect playback quality.

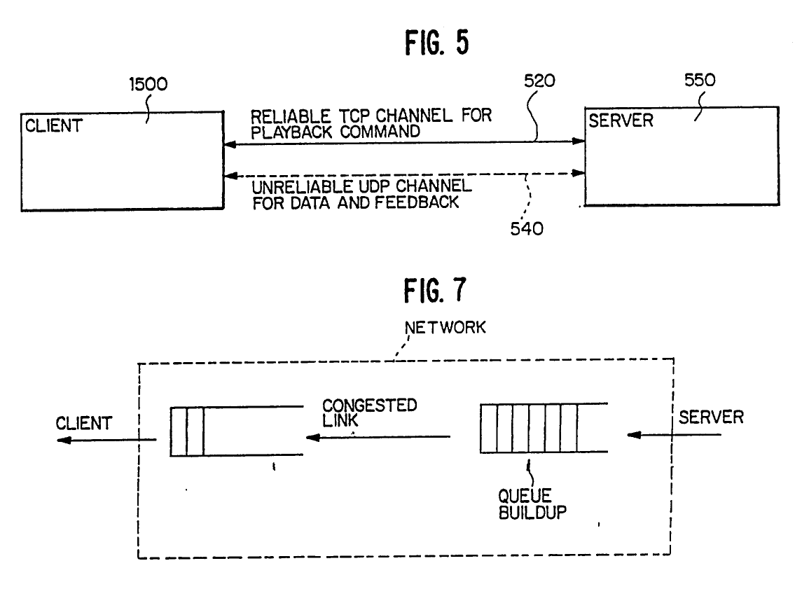

VDP is an asymmetric protocol. As shown in FIG. 5, between the client 500 and the server 550, there are two network channels 520, 540. The first channel 520 is a reliable TCP connection stream, upon which video parameters and playback commands (such as Play, Stop, Rewind and Fast Forward) are sent between client and server. These commands are sent on the reliable TCP channel 520 because it is imperative that playback commands are transmitted reliably. The TCP protocol provides that reliable connection between client and server.

The second network channel 540 is an unreliable user datagram protocol (UDP) connection stream, upon which video and audio data, as well as feedback messages are sent. This connection stream forms a feedback loop, in which the client receives video and audio data from the server, and feeds back information to the server that the server will use to moderate its rate of transmission of data. Video and audio data is transmitted on this unreliable channel because video and audio can tolerate losses. It is not essential that all data for such continuous media be transmitted reliably, because packet loss in a video or audio stream causes only momentary frame or sound loss.

Note that while, in accordance with a preferred embodiment, VDP is layered directly on top of UDP, VDP can also be encapsulated within Internet standards such as RTP, with RTCP as the feedback channel.

VDP Transmission Mechanism

After the admission controller 420 (FIG. 4) in server 550 (FIG. 5) grants the request from the client 500, the server 550 waits for the play command from the client. Upon receiving the play command, the server starts to send the video frames on the data channel using the recorded frame rate. The server end breaks large frames into smaller packets (for example, 8 kilobyte packets), and the client end reassembles the packets into frames. Each frame is time-stamped by the server and buffered at the client side. The client controls the sending of frames by sending server control commands, like stop or fast forward, on the control channel.

VDP Adaptation Algorithm

The VDP adaptation algorithm dynamically adapts the video transmission rate to network conditions along the network span from the client to the server, as well as to the client end's processing capacity. The algorithm degrades or upgrades the server transmission rate depending on feed forward and feedback messages exchanged on the control channel. This design is based on the consideration of saving network bandwidth.

Protocols for the transmission of continuous media over the Internet, or over other networks for that matter, need to preserve network bandwidth as much as possible. If a client does not have enough processor capacity, it may not be fast enough to decode video and audio data. Network connections may also impose constraints on the frame rate at which video data can be sent. In such cases, the server must gracefully degrade the quality of service. The server learns of the status of the connection from client feedback.

Feedback messages are of two types. A first type, the frame drop rate, corresponds to frames received by the client but which have been dropped because the client did not have enough CPU power to keep up with decoding the frames. The second type, the packet drop rate, corresponds to frames lost in the network because of network congestion.

If the client side protocol discovers that the client application is not reading received frames quickly enough, it updates the frame loss rate. If the loss rate is severe, the client sends the information to the server. The server then adjusts its transmission speed accordingly. In accordance with a preferred embodiment, the server slows down its transmission if the loss rate exceeds 15%, and speeds up if the loss rate is below 5%. However, it should be understood that the 15% and 5% figures are engineering thresholds, which can vary for any number of reasons, depending on conditions, outcomes of experiments, and the like.

In response to a video request, the server begins by sending out frames using the recorded frame rate. The server inserts a special packet in the data stream indicating the number of packets sent out so far. On receiving the feed forward message from the server, the client may then calculate the packet drop rate. The client returns the feedback message to the server on the control channel. In accordance with a preferred embodiment, feedback occurs every 30 frames. Adaptation occurs very quickly—on the order of a few seconds.

Demand Resend Algorithm

The compression algorithms in some media formats use inter-frame dependent encoding. For example, a sequence of MPEG video frames has I, P, and B frames. I frames are frames that are intra-frame coded with JPEG compression. P frames are frames that are predictively coded with respect to a past picture. B frames are frames that are bidirectionally predictive coded.

MPEG frames are arranged into groups with sequences that correspond to the pattern I B B P B B P B B. The I frame is needed by all P and B frames in order to be decoded. The P frames are needed by all B frames. This encoding method makes some frames more important than the others. The display quality is strongly dependent on the receipt of important frames. Since data transmission can be unreliable over the Internet, there is a possibility of frame loss. If, in a sequence group of MPEG video frames I B B P B B P B B recorded at 9 frames/sec, the I frame is lost, the entire sequence becomes undecodable. This undecodability produces a one second gap in the video stream.

Some protocols, such as Cyclic-UDP, use a priority scheme in which the server sends the important frames repeatedly within the allowable time interval, so that the important frames have a better chance of getting through. VDP's demand resend is similar to Cyclic-UDP in that, in VDP, the responsibility of determining which frames are resent is put on the client based on its knowledge of the encoding format used by the video stream. However, unlike Cyclic-UDP, VDP does not rely on the server's repeated retransmission of frames, because such repeated retransmission would be more likely to cause unacceptable jitter. Accordingly, in an MPEG stream, the VDP algorithm may choose to request retransmissions of only the I frames, or of both the I and P frames, or all frames. VDP employs a buffer queue at least as large as the number of frames required during one round trip time between the client and the server. The buffer is full before the protocol begins handing frames to the client from the queue head. New frames enter at the queue tail. A demand resend algorithm is used to generate resend requests to the server in the event a frame is missing from the queue tail. Since the buffer queue is large enough, it is highly likely that re-sent frames can be correctly inserted into the queue before the application requires it.

The following is the client/server setup negotiation, in which a client computer contacts the video server to request a video or audio file. Referring to FIG. 5, which is a schematic depiction of a client-server channel setup, the sequence is as follows:

The client 500 first contacts the server 550 by initiating a reliable TCP network connection to the server over channel 520.

If the connection is successfully set up, the client 500 then chooses a UDP port (say u), and establishes communication over channel 540. The client 500 then sends to the server 550, over the port u, the name of the video or audio file requested.

If the server 550 finds the requested file, and the server 550 can accept the video or audio connection, then the client 500 prepares to receive data on UDP port u.

When the client 500 wishes to receive data from the server 550, the client sends a Play command to the server 550 on the reliable TCP charnel 520. The server 550 will then start streaming data to the client 500 at port u.

The particular setup sequence just described, which the currently preferred implementation of VDP uses, illustrates how the two connections, reliable and unreliable, are set up. However, the particular sequence is not essential to the proper functioning of the adaptive algorithm.

The VDP server 550 is in charge of transmitting requested video and audio data to the client 500. The server receives playback commands from the client through the reliable TCP channel, and sends data on an unreliable UDP channel to the client. It also receives feedback messages from the client, informing it of the conditions detected at the client. It uses these feedback messages to moderate the amount of data transmitted in order to smooth out transmission under congested conditions.

The server streams data at the proper rate for the type of data requested. For example, a video that is recorded at 24 frames per second will have its data packetized and transmitted such that 24 frames worth of data is transmitted every second. An audio segment that is recorded at 12 Kbit/s will be packetized and transmitted at that same rate.

For its part, the client sends playback commands, including Fast Forward, Rewind, Stop and Play, to the server on the reliable TCP channel. It also receives video and audio data from the server on the unreliable UDP channel.

As packets arriving from the network are subject to some degree of jitter, a playout buffer is used to smooth jitter between continuous media frames. The playout buffer is of some length l, measured in frame time. For reasons described later, l=p×RTT, where RTT is the Round Trip Time between the client and the server, and p is some factor ≦1.

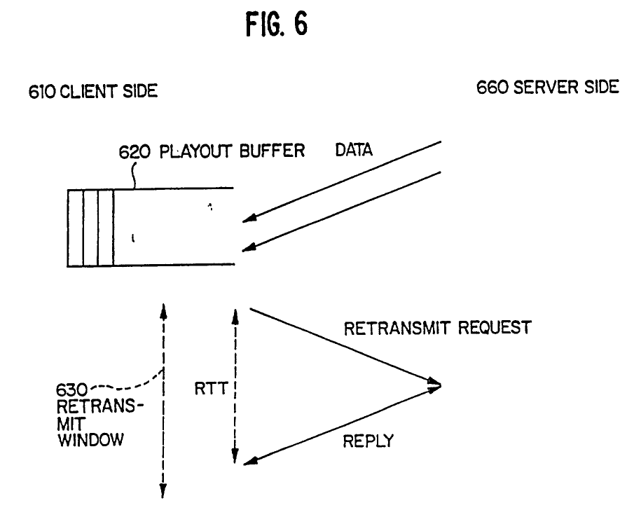

FIG. 6 depicts retransmission and size of the buffer queue. On the client side 610, a playout buffer 620 is also used to allow retransmission of important frames which are lost. VDP uses a retransmit once scheme, i.e. retransmit requests for a lost frame are only sent once. The protocol does not require that data behind the lost packet be held up for delivery until the lost packet is correctly delivered. Packets are time stamped and have sequence numbers. Lost frames are detected at the tail of the queue. A retransmission request 650 is sent to the server side 660 if a decision is made on the client side 610 that a frame has been lost (a packet with a sequence number more than what was expected arrives). p must be greater than or equal to 1 in order that the lost frame have enough time to arrive before its slot arrives at the head of the queue. The exact value of p is an engineering decision.

The protocol must also guard against retransmission causing a cascade effect. Since a retransmitted frame increases the bandwidth of data when it is transmitted again, it may cause further loss of data. Retransmit requests issued for these subsequent lost packets can trigger more loss again. VDP avoids the cascade effect by limiting retransmits. As a retransmission takes one round trip time from sensing the retransmission request to having the previously lost data arrive, the limit is one retransmission request for any frame within a retransmit window 630, equal to w×RTT for w>1.

The VDP adaptive algorithm detects two types of congestion. The first type, network congestion, results from insufficient bandwidth in the network connection to sustain the frame rate required for video and audio. The second type, CPU congestion, results from insufficient processor bandwidth required for decoding the compressed video and audio.

To identify and address both types of congestion, feedback is returned to the server in order for the server to moderate its transmission rate. Moderation is accomplished by thinning the video stream, either by not sending as many frames, or by reducing image quality by not sending high resolution components of the picture. Audio data is never thinned. The loss of audio data results in glitches in the playback, and are more perceptually disturbing to the user than is degradation of video quality. Thinning techniques for video data are well known, and so need not be described in detail here.

When the network is congested, there is insufficient bandwidth to accommodate all the traffic. As a result, data that would normally arrive fairly quickly is delayed in the network, as network queues build up in intermediate routers between client and server. Since the server transmits data at regular intervals, the interval between subsequent data packets increases in the presence of network congestion.

The protocol thus detects congestion by measuring the inter-arrival times between subsequent packets. Inter-arrival times exceeding the expected value signal the onset of network congestion; such information is fed back to the server. The server then thins the video stream to reduce the amount of data injected into the network.

Because of packet jitter within the network, inter-arrival times between subsequent packets may vary in the absence of network congestion. A low-pass filter is used to remove the transient effects of packet jitter. Given the difference in arrival time between packets i and packets i+1 of δt, the inter-arrival time tᵢ₊₁ at time i+1 is:

t_{i-30 1}=(1−α))×tᵢ+α×δt,0≦α≦1 (1)

The filter provides a cumulative history of the inter-arrival time while removing transient differences in packet inter-arrival times.

Packet loss is also indicative of network congestion. As the amount of queuing space in network routers is finite, excessive traffic may be dropped if there is not enough queue space. In VDP, packet loss exceeding and engineering threshold is also indicative of network congestion.

CPU congestion occurs when there is too much data for the client CPU to decode. As VDP transports compressed video and audio data, the client processor is required to decode the compressed data. Some clients may possess insufficient processor bandwidth to keep up. In addition, in modern time sharing environments, the client's processor is shared between several tasks. A user starting up a new task may reduce the amount of processor bandwidth available to decode video and audio. Without adaptation to CPU congestion, the client will fall behind in decoding the continuous media data, resulting in slow motion playback. As this is undesirable, VDP also detects CPU congestion on the client side.

CPU congestion is detected by directly measuring if the client CPU is keeping up with decoding the incoming data.

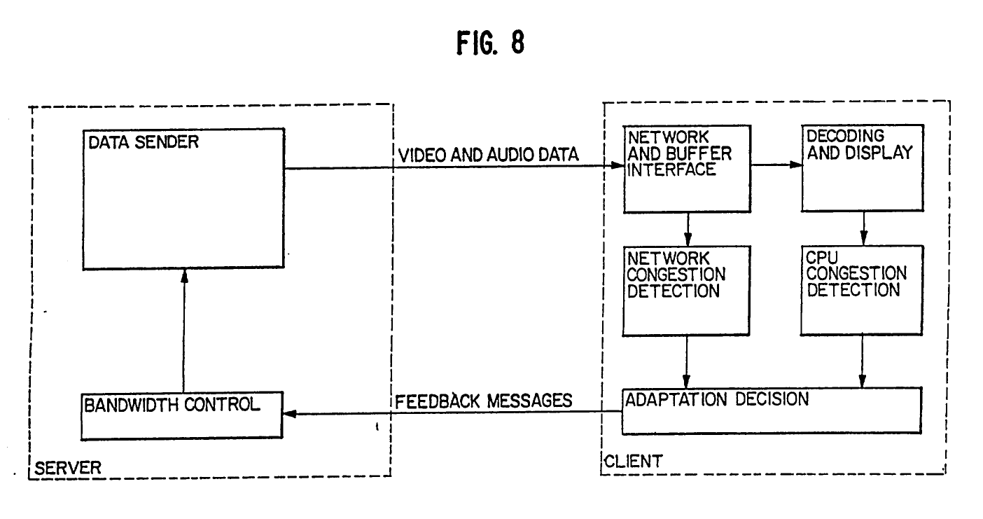

FIG. 7 depicts buildup of a queue of continuous media information in the presence of network congestion. FIG. 8 depicts a flow graph for handling feedback and transmission/reception adaptation under varying loads and levels of congestion.

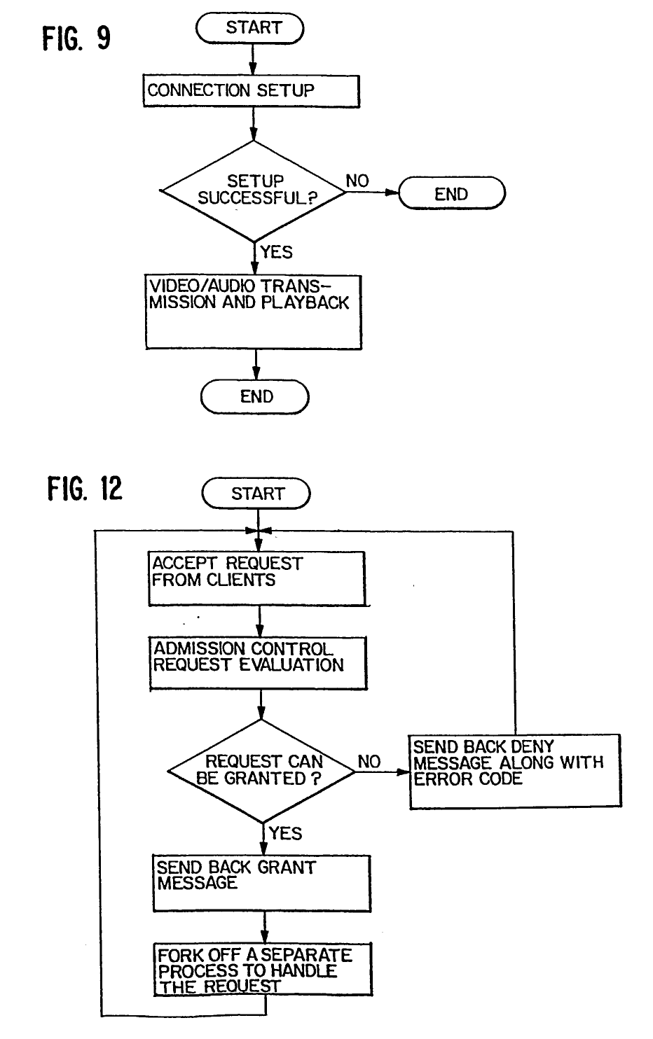

FIGS. 9-13 are flow charts depicting the sequence of VDP operations at the respective client and the server sides. In FIG. 9, depicting a top level operational flow at the client side, the connection setup sequence is initiated. If the setup is successful, video/audio transmission and playback is initiated. If the setup is not successful, operation ends.

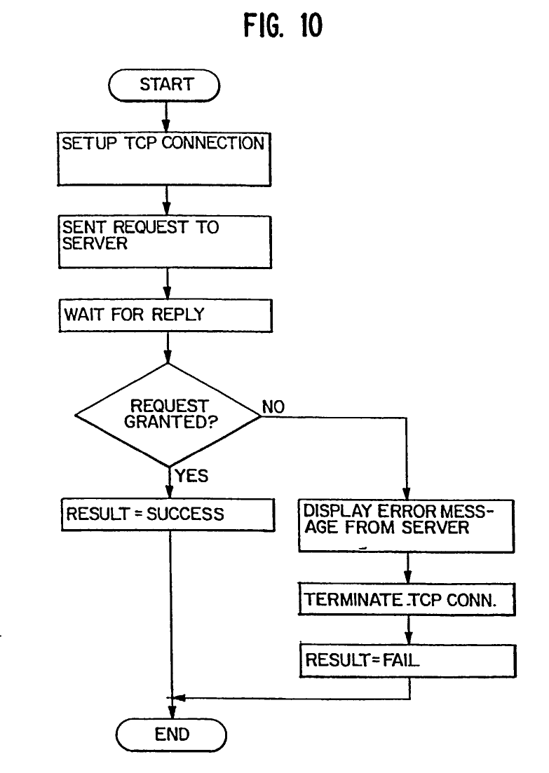

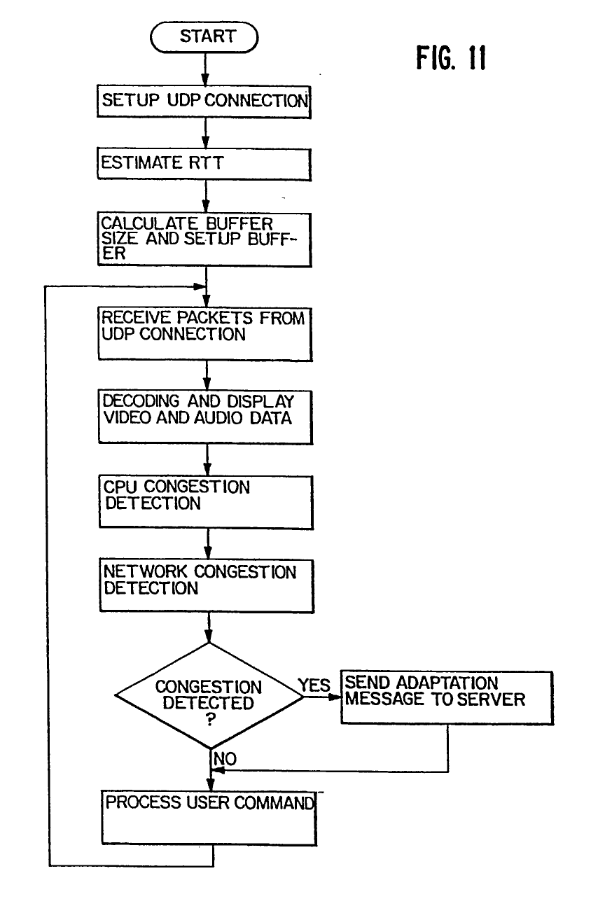

In FIG. 10, depicting the flow of setup of a client connection, first a TCP connection is set up, and then a request is sent to the server. If the request is granted, the connection is considered successful, and playback is initiated. If the request is not granted, the server sends an error message, and the TCP connection is terminated.

In FIG. 11, once the TCP connection is set up successfully, and communication established successfully with the server, a UDP connection is set up. Round trip time (RTT) is estimated, and then buffer size is calculated, and the buffer is set up. The client then receives packets from the UDP connection, and decodes and displays video and audio data. The presence or absence of CPU congestion is detected, and then the presence or absence of network congestion is detected. If congestion at either point is detected, the client sends a message to the server, telling the server to modify its transmission rate. If there is no congestion, the user command is processed, and the client continues to receive packets from the UDP connection. As can be seen from the Figure, a feedback loop is set up in which transmission from the server to the client is modified based on presence of congestion. Thus, rather than the client simply telling the server to continue sending, the client actually tells the server, under circumstances of congestion, to modify its sending rate.

FIG. 12 shows the server's side of the handling of client requests. The server accepts requests from a client, and evaluates the client's admission control request. If the request can be granted, the server sends a grant, and initiates a separate process to handle the client's request. If the request cannot be granted, the server sends a denial to the client, and goes back to looking for further client requests.

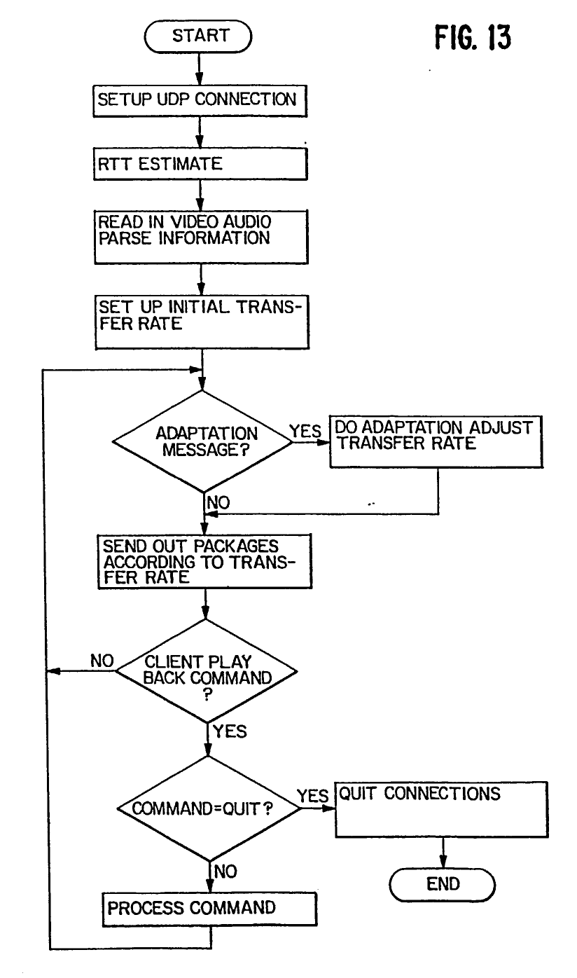

FIG. 13 depicts the server's internal handling of a client request. First, a UDP connection is set up. Then, RTT is estimated. Video/audio parse information then is read in, and an initial transfer rate is set. If the server receives a message from the client, asking for a modification of the transfer rate, the server adjusts the rate, and then sends out packets accordingly. If there is no request for transfer rate modification, then the server continues to send out packets at the previous (most recent) transfer rate. If the client has sent a playback command, then the server looks for an adaptation message, and continues to send packets. If the client has sent a “quit” command, the TCP and UDP connections are terminated.

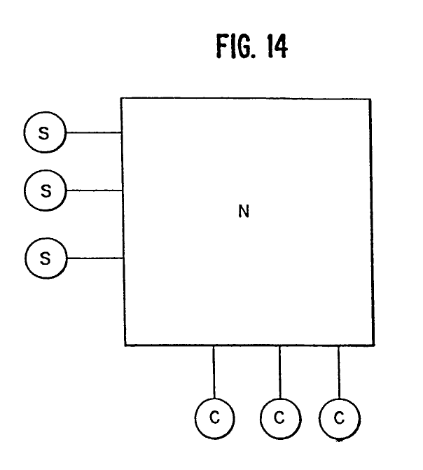

FIG. 14 shows, in broad outline, the hardware environment in which the present invention operates. A plurality of servers and clients are connected over a network. In the preferred embodiment, the network is the Internet, but it is within the contemplation of the invention to replace other network protocols, whether in LANs. MANs, or WANs, with the inventive protocol, since the use of TCP/IP is not limited to the Internet, but indeed pertains over other types of networks.

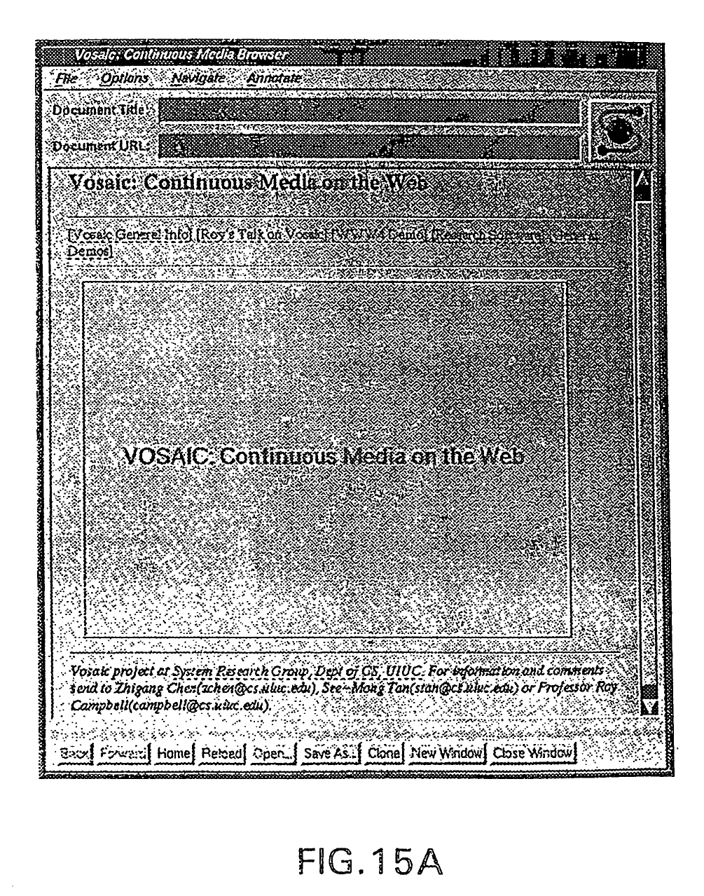

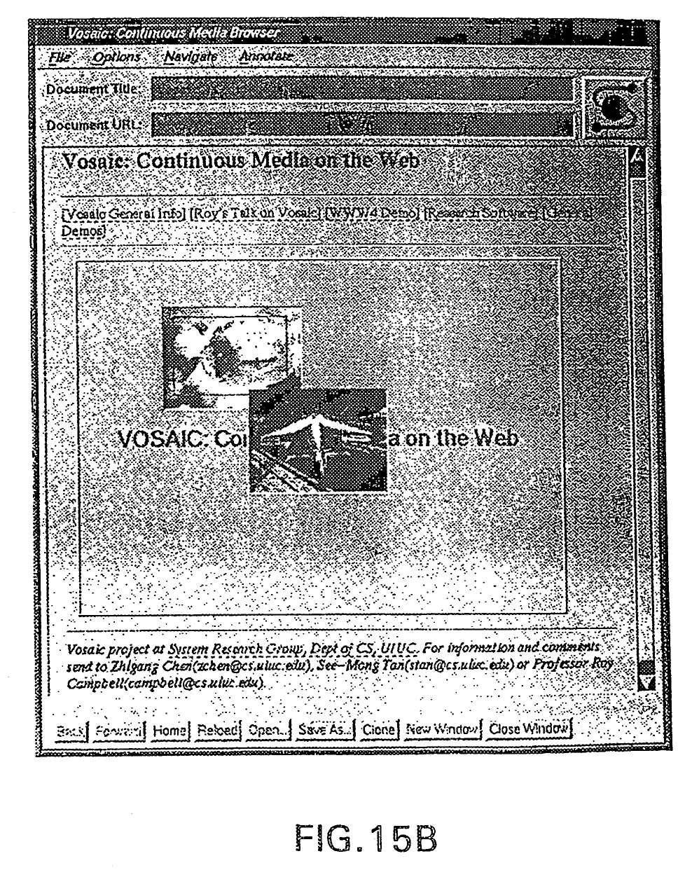

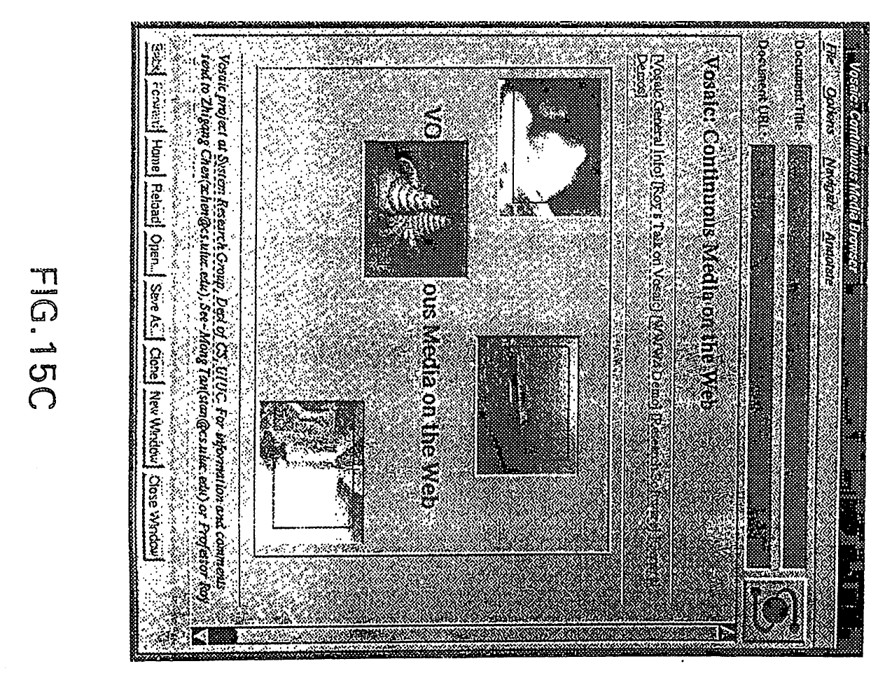

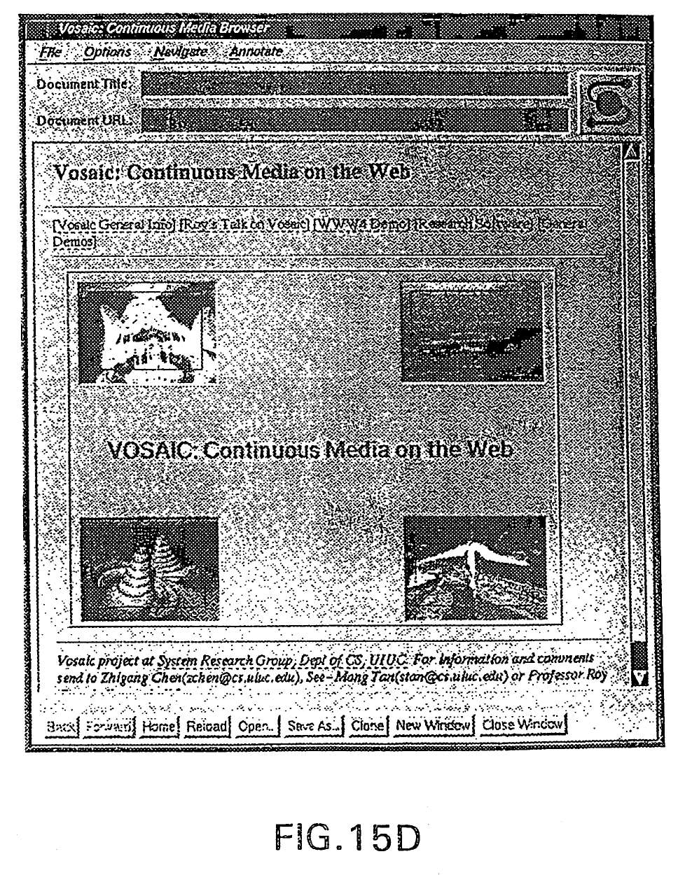

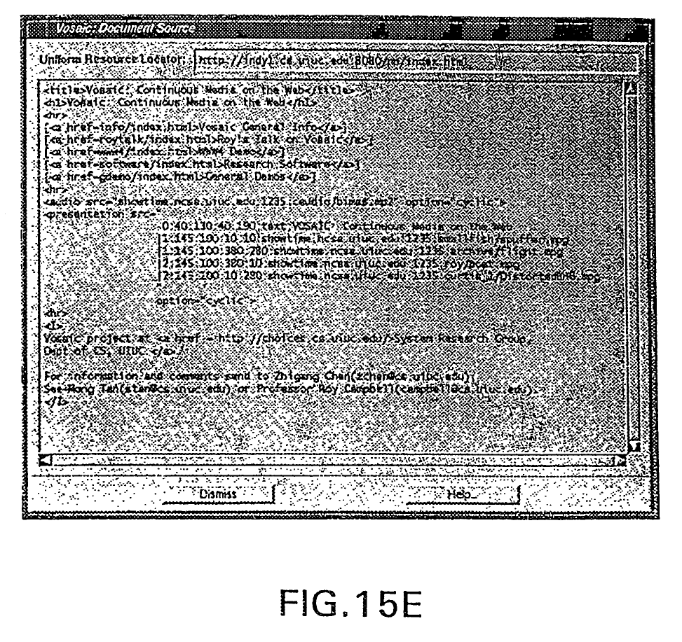

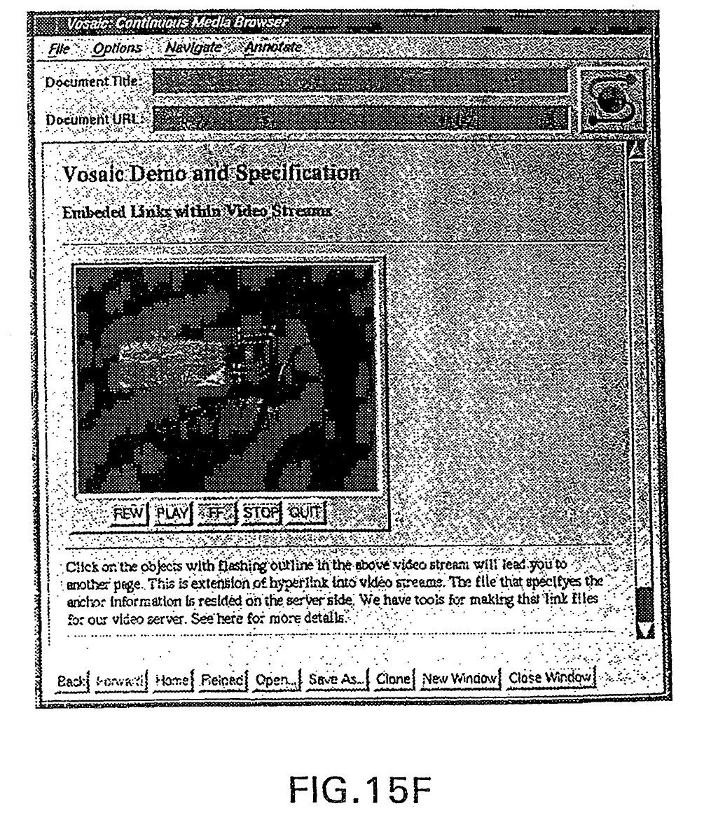

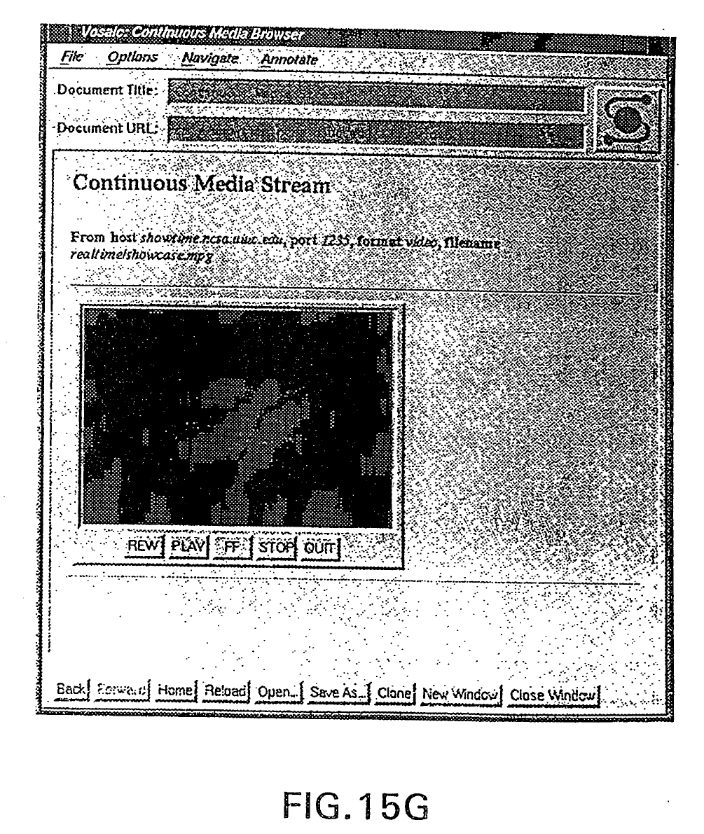

FIGS. 15a-15g, similarly to FIGS. 1 and 3, show further examples of types of display screens which a user would encounter in the course of using Vosaic. FIGS. 15a-15d depict various frames of a dynamic presentation. FIG. 15a shows an introductory text screen. FIG. 15b shows two videos displayed on the same screen, using the present invention. FIG. 15c shows a total of four videos displayed on the same screen. FIG. 15d illustrates the appearance of the screen at the end of the videos presented in FIG. 15c.

FIG. 15e shows the source which invokes the presentation depicted in FIGS. 15a-15d. FIG. 15f illustrates an interface screen with hyperlinks in video objects, in the boxed area within the video. Also, similarly to FIG. 3, a control panel is shown with controls similar to those of a videocassette recorder (VCR), to control playback of videos. Clicking on the hyperlinked region in FIG. 15f results in the page shown in FIG. 15g, which is the video to be played.

The inventors carried out several experiments over the Internet. The test data set consisted of four MPEG movies, digitized at rates ranging from 5 to 9 fps, with pixel resolution ranging from 160 by 120 to 320 by 240. Table 1 below identifies the test videos that were used.

TABLE 1
MPEG test movies.

| | Frame | | Number | |
|---|---|---|---|---|
| Name | Rate (fps) | Resolution | of Frames | Play Time (secs) |
| model.mpg | 9 | 160 by 120 | 127 | 14 |
| startrek.mpg | 5 | 208 by 156 | 642 | 128 |
| puffer.mpg | 5 | 320 by 240 | 175 | 35 |
| smalllogo.mpg | 5 | 320 by 240 | 1622 | 324 |

The videos listed in Table 1 ranged from a short 14 second segment to one of several minutes duration.

In order to observe the playback video quality, the inventors based the client side of the tests in the laboratory. In order to cover the widest possible range of configurations, servers were set up corresponding to local, regional and international sites relative to the geographical location of the laboratory. A server was used at the National Center for Supercomputing Applications (NCSA) for the local case. NCSA is connected to the local campus network at the University of Illinois/Champaign-Urbana via Ethernet. For the regional case, a server was used at the University of Washington. Finally, a copy of the server was set up at the University of Oslo in Norway to cover the international case. Table 2 below lists the names and IP addresses of the hosts used for the experiments.

TABLE 2
Hosts used in our tests.

| Name | IP Address | Function |
|---|---|---|
| indy1.cs.uiuc.edu | 128.174.240.90 | local client |
| showtime.ncsa.uiuc.edu | 141.142.3.37 | local server |
| agni.wtc.washington.edu | 128.95.78.229 | regional server |
| gloin.ifi.uio.no | 129.240.106.18 | international server |

TABLE 3
Local test.

| Name | % Dropped Frames | Jitter (ms) |
|---|---|---|
| model | 0 | 8.5 |
| startrek | 0 | 5.9 |
| puffer | 7.5 | 43.6 |
| smalllogo | 0.5 | 22.5 |

TABLE 4
Regional test.

| Name | % Dropped Frames | Jitter (ms) |
|---|---|---|
| model | 0 | 46.3 |
| startrek | 0 | 57.1 |
| puffer | 0 | 34.3 |
| smalllogo | 0.2 | 50.0 |

TABLE 5
International test.

| Name | % Dropped Frames | Jitter (ms) |
|---|---|---|
| model | 0 | 20.1 |
| startrek | 0 | 22.0 |
| puffer | 19 | 121.4 |
| smalllogo | 0.8 | 46.7 |

Tables 3-5 show the results for sample runs using the test videos by the Web client accessing the local, regional and international servers respectively. Each test involved the Web client retrieving a single MPEG video clip. An unloaded Silicon Graphics (SGI) Indy was used as the client workstation. The numbers give the average frame drop percentage and average application-level inter-frame jitter in milliseconds for thirty test runs. Frame rate changes because of to the adaptive algorithm were seen in only one run. That run used the puffer.mpg test video in the international configuration (Oslo, Norway to Urbana, USA). The frame rate dropped from 5 fps to 4 fps at frame number 100, then increased from 4 fps to 5 fps at frame number 126. The rate change indicated that transient network congestion caused the video to degrade for a 5.2 second period during the transmission.

The results indicate that the Internet supports a video-enhanced Web service. Inter-frame jitter in the local configuration is negligible, and below the threshold of human observability (usually 100 ms) in the regional case. Except for the puffer.mpg runs, the same holds true for the international configuration. In the puffer.mpg case, the adaptive algorithm was invoked because of dropped frames and the video quality was degraded for a 5.2 second interval. The VDP buffer queue efficiently minimizes frame jitter at the application level.

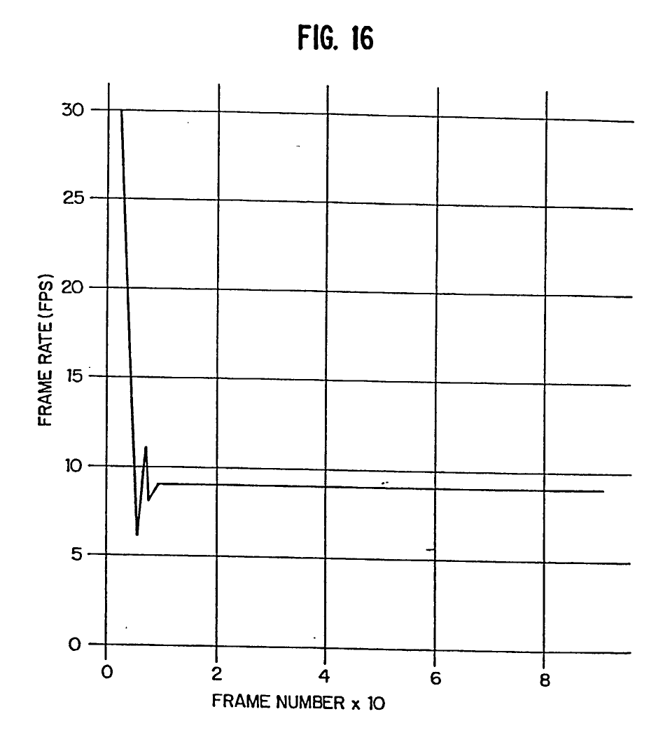

The last test exercised the adaptive algorithm more strongly. Using the local configuration, a version of smalllogo.mpg recorded at 30 fps at a pixel resolution of 320 by 240 was retrieved. This is a medium size, high quality video clip, requiring significant computing resources for playback. FIG. 16 shows a graph of frame rate versus frame sequence number for the server transmitting the video.

The client side buffer queue was set at 200 frames, corresponding to about 6.67 seconds of video. The buffer at the client side first filled up, and the first frame was handed to the application at frame number 200. The client workstation did not have enough processing capacity to decode the video stream at the full 30 fps rate. The client side protocol detected a frame loss rate severe enough to report to the server at frame number 230. In accordance with a presently preferred embodiment, transmission is degraded when the frame loss rate exceeds 15%. Transmission is upgraded if the loss rate is below 5%.

The server began degrading its transmission at frame number 268, that is, within 1.3 seconds of the client's detection that its CPU was unable to keep up. The optimal transmission level was reached in 7.8 seconds, corresponding to a 9 frame per second transmission rate. Stability was reached in a further 14.8 seconds. The deviation from optimal did not exceed 3 frames per second in either direction during that period. The results show a fundamental tension between large buffer queue sizes that minimize jitter and server response times.

The test with very high quality video at 30 fps with a frame size of 320 by 240 represents a pathological case. However, the results show that the adaptive algorithm is an attractive way to reach optimal frame transmission rates for video in the WWW. The test implementation changes the video quality by 1 frame per second at each iteration. It is within the contemplation of the invention to employ non-linear schemes based on more sophisticated policies.

In accordance with another aspect of the invention, continuous media organization, storage and retrieval is provided. Continuous media consist of video and audio information, as well as so-called meta-information which describes the contents of the video and audio information. Several classes of meta-information are identified in order to support flexible access and efficient reuse of continuous media. The meta-information encompasses the inherent properties of the media, hierarchical information, semantic description, as well as annotations that provide support for hierarchical access, browsing, searching, and dynamic composition of continuous media.

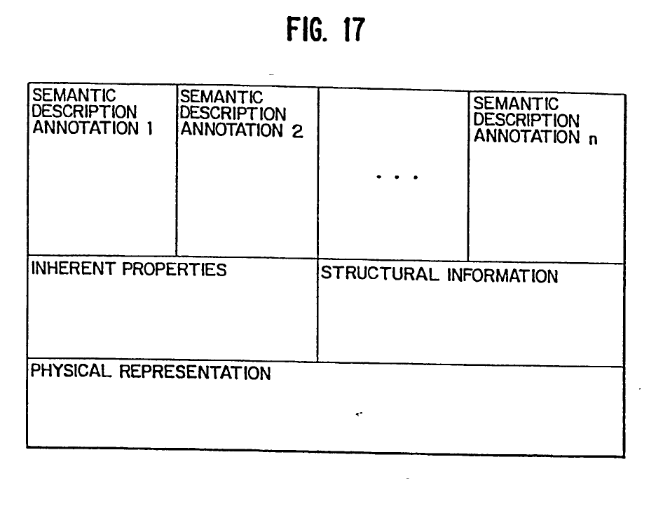

As shown in FIG. 17, the continuous media integrates video and audio documents with their meta-information. That is, the meta-information is stored together with the encoded video and audio. Several classes of meta-information include:

Inherent properties: The encoding scheme specification, encoding parameters, frame access points and other media-specific information. For example, for a video clip encoded in the MPEG format, the encoding scheme is MPEG, and the encoding parameters include the frame rate, bit rate, encoding pattern, and picture size. The access points are the file offsets of important frames.

Hierarchical structure: Hierarchical structure of video and audio. For example, a movie often consists of a sequence of clips. Each clip is made of a sequence of shots (scenes), while each shot includes a group of frames.

Semantic descriptions: Descriptions of the parts, or of the whole video/audio document. Semantic descriptions facilitate search. Searching through large video and audio clips is hard without semantic description support.

Semantic Annotations: Hyperlink specifications for objects inside the media streams. For example, for an interesting object in a movie, a hyperlink can be provided which leads to related information. Annotation information allows the browsing of continuous media and can integrate video and audio with static data types like text and images.

Inherent properties assist in the network transmission of continuous media. They also provide random access points into the document. For example, substantial detail has been provided above, describing the inventive adaptive scheme for transmitting video and audio over packet-switched networks with no quality of service guarantees. The scheme adapts to the network and processor load by adjusting the transmission rate. The scheme relies on the knowledge of the encoding parameters, such as the bit rate, frame rate and encoding pattern.

Information about frame access points enables frame-based addressing. Frame addressing allows accesses to video and audio by frame number. For example, a user can request a portion of a video document from frame number 1000 to frame number 2000. Frame addressing make frames the basic access unit. Higher level meta-information, such as structural information and semantic descriptions, can be built by associating a description with a range of frames.

The encoding within the media stream often includes several of the inherent properties of meta-information. These parameters are extracted and stored separately, as on-the-fly extraction is expensive. On-the-fly extraction unnecessarily burdens the server and limits the number of requests that the server can serve concurrently.

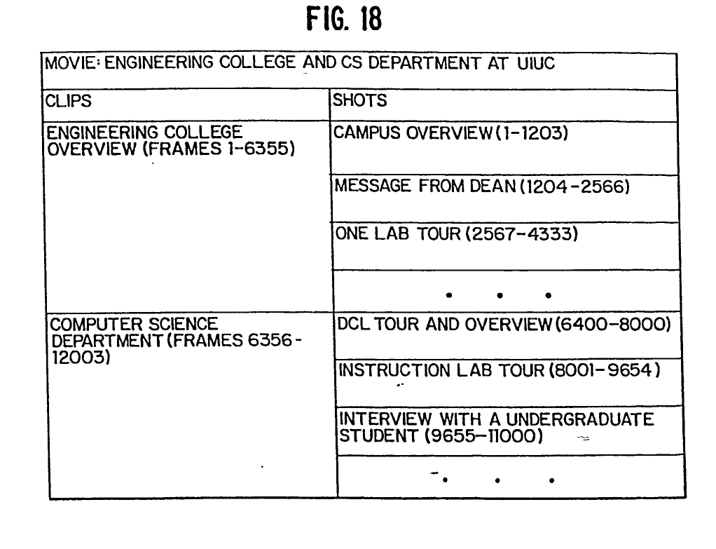

A video or audio document often possesses a hierarchical structure. An example of hierarchical information in a movie is shown in FIG. 18. The movie example in that Figure, “Engineering College and CS Department at UIUC” consists of the clips “Engineering College Overview” and “CS Department Overview”. Each of these clips is composed of a sequence of shots; in the case of “Engineering College Overview,” the sequence consists of “Campus Overview”, “Message from Dean,” and others. The hierarchical structure describes the organizational structure of continuous media, making hierarchical access and non-linear views of continuous media possible.

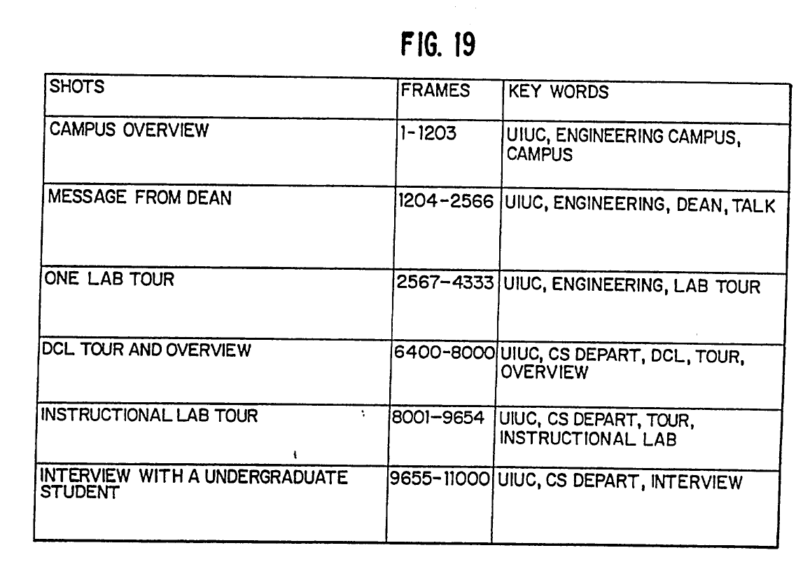

Semantic descriptions describe part or the whole video/audio document. A range of frames can be associated with a description. As shown in FIG. 19, the shots in the example movies are associated (indexed) with keywords. Semantic annotations describe how a certain object within a continuous media stream is related to some other object. Hyperlinks can be embedded to indicate this relationship.

Continuous media allows multiple annotations and semantic descriptions. Different users can describe and annotate in different ways. This is essential in supporting multiple views on the same physical media. For example, a user may describe the campus overview shot in the example movie as “UIUC campus”, while another user may associate it with “Georgian style architecture in the United States Midwest”. That user may have a link from his/her presentation to introduce the UIUC campus, while another user may use relative frames of the same video segment to describe Georgian-style architecture.

Supporting multiple views considerably simplifies content preparation. This is because only one copy of the physical media is needed. Users can use part or the whole copy for different purposes.

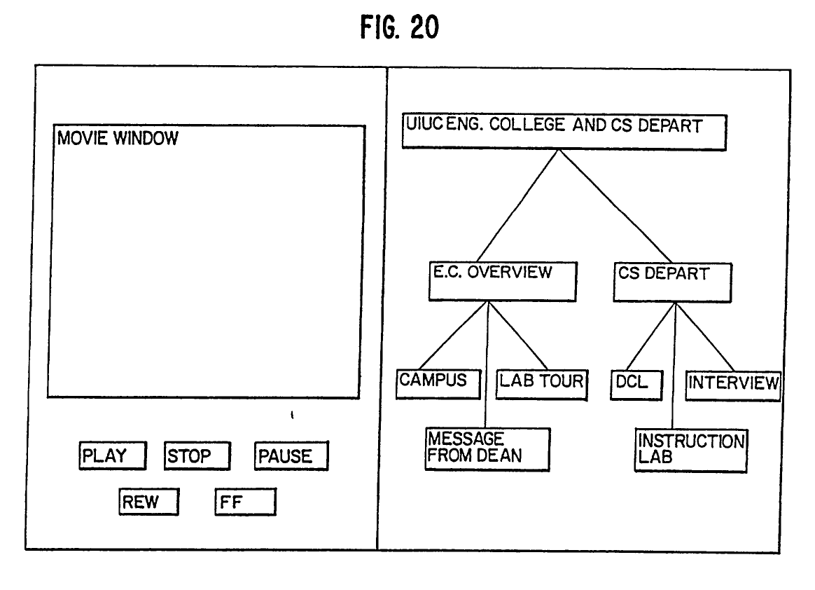

The meta-information described above is essential in supporting flexible access and efficient reuse. The hierarchical information can be displayed along with the video to provide the user a view of the overall structure of the video. It allows the user to access to any desired clip, and any desired shot. FIG. 20 shows an implementation of the video player in Vosaic; specifically, a movie is shown along with its hierarchical structure. Each node is associated with a description. A user can click on nodes of the structure and that portion of the movie will be shown in the movie window.

Hierarchical access enables a non-linear view of video and audio, and facilitates greatly the browsing of video and audio materials. Video and audio documents traditionally have been organized linearly. Even though traditional access methods, such as the VCR type of operations, or the slide bar operation, allow arbitrary positioning inside video and audio streams, finding the interesting parts within a video presentation is difficult without strong contextual knowledge, since video and audio express meanings through the temporal dimension. In other words, a user cannot easily understand the meaning of one frame without seeing related frames and shots. Displaying hierarchical structure and descriptions provides users with a global picture of what the movie and each part is about.

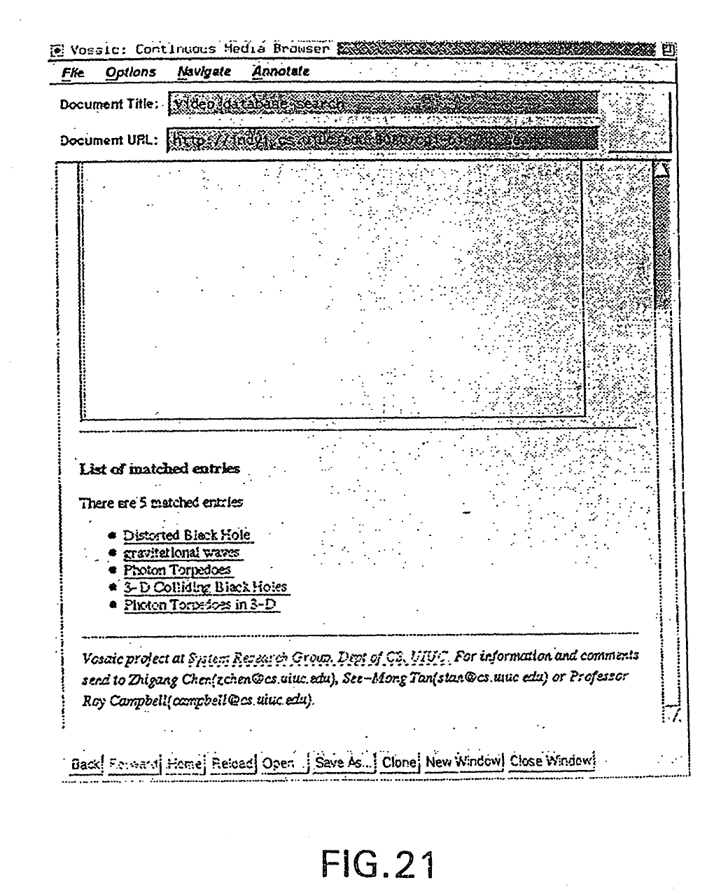

Searching capability can be supported by searching through the semantic description. For example, the keyword descriptions in FIG. 19 can be queried. The search of keyword tour will return all the tours in the movie, e.g., One Lab Tour, DCL Tour, and Instructional Lab Tour. One implementation of a search is shown in FIG. 21, in which the matched entries for the query are listed.

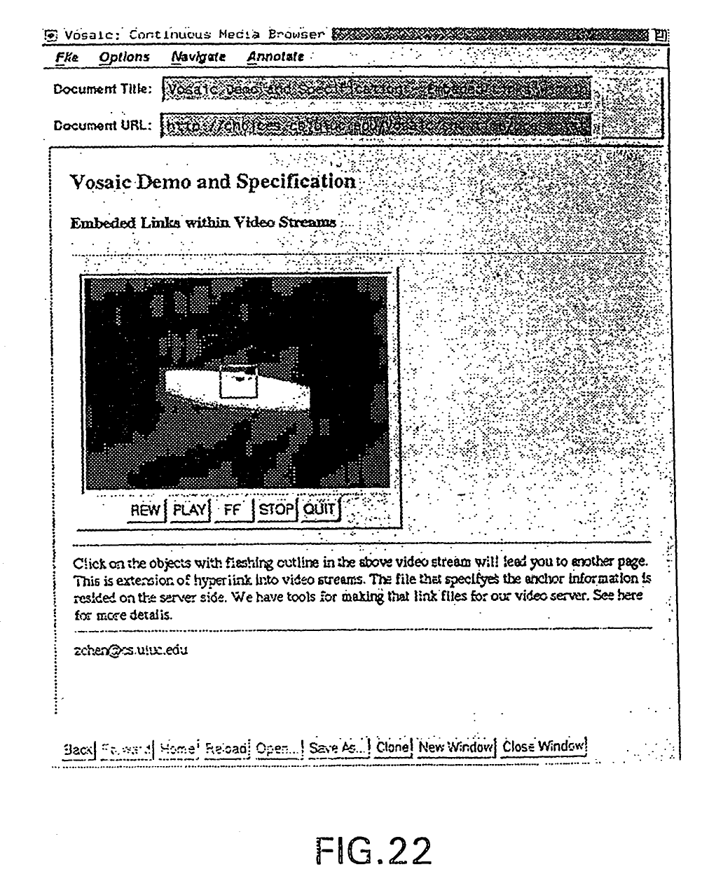

Browsing is supported through hyperlinks embedded within video streams and through hierarchical access. Hyperlinks within video streams are an extension of the general hyperlink principle, in this case, making objects within video streams anchors for other documents. As shown in FIG. 22, a rectangle outlining a black hole object indicates that it is a anchor, and upon clicking the outline, the document to which it is linked is fetched and displayed (in this case, an HTML document about black holes). Hyperlinks within video streams integrate and facilitate inter-operation between video streams and traditional static text and images.

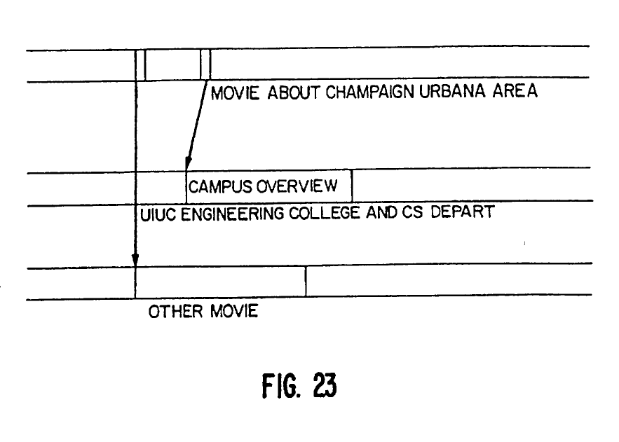

Continuous media also allows dynamic composition. A video presentation can use parts of existing movies as components. For example, a presentation of Urbana-Champaign can be a video composed of several segments from other movies. As shown in FIG. 23, the campus overview segment can be used in the composition. The specification of this composition is done through hyperlinks.

Vosaic's architecture is based on continuous media, as outlined above. Meta-information is stored on the server side together with the media clips. Inherent properties are used by the server in order to adapt the network transmission of continuous media to network conditions and client processor load. Semantic description and annotations are used for searching video material and hyperlinking inside video streams. In the design and implementation of tools for the extraction and construction of continuous media meta-information, a parser was developed to extract inherent properties from encoded MPEG video and audio streams. A link-editor was implemented for the specification of hyperlinks within video streams. There also are tools for video segmentation and semantic description editing.

Frame addressing uses the video frame and the audio sample as basic data access units to video and audio, respectively. During the initial connection phase between Vosaic server and client, the start and end frames for specific video and audio segments are specified. The default settings are the start and the end frame of the whole clip. The server transmits only the specified segment of video and audio to the client. For example, for a movie that is digitized as a whole and is stored on the server, the system allows a user to request frame number 2567 to frame number 4333. The server identifies and retrieves this segment, and transmits the appropriate frames to the client.

A parser has been developed for extracting inherent properties from MPEG video and audio streams. The parsing is done off-line. The parse file contains:

1. picture size, the frame rate, pattern,

2. average frame size, and

3. offset for each frame

in the clip file.

A example parse file is shown below:

#

#

#------------------------------------------------------------------

# cs.mpg.par

#

#Parse file for MPEG stream file

#This file is generated by mparse, a parse tool for MPEG stream file.

#For more information, send mail to:

#

#zchen@cs.uiuc.edu

#Zhigang Chen, Department of Computer Science

#University of Illinois at Urbana-Champaign

#

#format:

#i1 h_size v_size frame rate bit rate frames total size

#i2 ave_size i_size p_size b_size ave_time i_time, p_time, b_time

#p1 pattern of first sequence

#p2 pattern of the rest of the sequence

#hd header_start header_end

#frame_number frame_type start_offset frame_size frame_time

#ed end start

#------------------------------------------------------------------

i1 160 112 15 262143 12216 8941060

i2 731 2152 510 7612511 20911 10443 8826

p1 7 ipbbibb

p2 7 ipbbibb

hd 0 12

0 1 12 2234 20377

. . .

A link editor enables the user to embed hyperlinks into video streams. The specification of a hyperlink for a object within video streams includes several parameters:

1. The start frame where the object appears and the object's position.

2. The end frame where the object exists and the object's position.

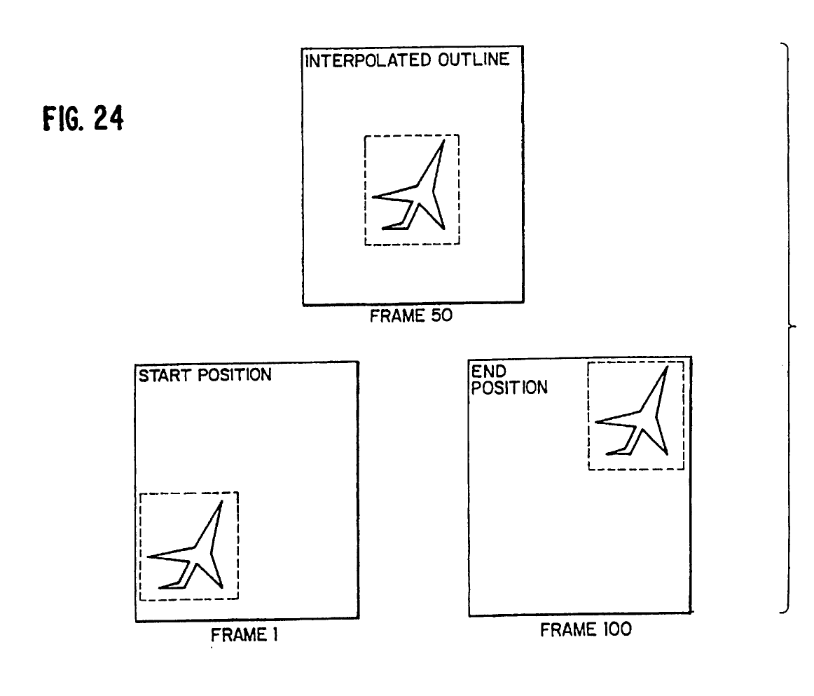

The positions of the object outline are interpolated for frames nestled in between the first and last frames specified. A simple scheme using linear interpolation is shown in FIG. 24. The position of the outline in the start frame (frame 1) and end frame (frame 100) are specified by the user. For frames in between, the position is interpolated, as shown, for example, in the frame 50.

In the currently preferred embodiment, linear interpolation is employed, and works well for objects with linear movement. However, for better motion tracking, sophisticated interpolation methods, such as spline-interpolation, may be desirable.

With respect to dynamic composition of video, for example, FIG. 21 illustrates the result of a search on a video database. The search result is a server-generated dynamic composition of the matched clips. The resulting presentation is a movie made up of the video clips in the search result.

In general, users may use the dynamic composition facilities of the invention to create and author continuous media presentations by reusing video segments through this facility. The organization of video through dynamic composition reduces the need for the copying of large video and audio documents.

Video segmentation and semantic description editing currently is performed manually. Video frames are grouped and descriptions are associated with the groups. The descriptions are stored and used for search and hierarchical structure presentation.

Meta-information and continuous media have been the subject of several studies. The Informedia project at CMU has proposed the use of automatic video segmentation and audio transcript generation for building large video libraries. Algorithms have been proposed for video segmentation. Hyperlinks in video streams have been proposed and implemented in the Hyper-G distributed information system, as well as in a World Wide Web context in Vosaic.

While previous work has focused on a particular aspect of meta-information, for example, in terms of support for search only, or for hyperlinking only, the present invention categorizes and integrates continuous media meta-information in order to support continuous media network transmission, access methods, and authoring. This approach can be generalized for static data. The generalized approach encourages the integration of continuous media with static media, document retrieval with document authoring. Multiple views of the same physical media are possible.

By integrating meta-information in the continuous media approach, flexible access and efficient reuse of continuous media in the World Wide Web are achieved. Several classes of meta-information are included in the continuous media approach. Inherent properties help network transmission of and provide random access to continuous media. Structural information provides hierarchical access and browsing. Semantic specifications allow search in continuous media. Annotations enable hyperlinks within video streams, and therefore facilitates the browsing and organization of irregular information in continuous media and static media through hyperlinks. The support of multiple semantic descriptions and annotations makes multiple views of the same material possible. Dynamic composition of video and audio is made possible by frame addressing and hyperlinks.

While the invention has been described in detail with reference to preferred embodiments, it is apparent that numerous variations within the scope and spirit of the invention will be apparent to those of working skill in this technological field. Consequently, the invention should be construed as limited only by the appended claims.

1. A system for transmitting real-time continuous media information over a network from a server to a client, said continuous media information comprising at least one of video and audio information, said system comprising:
a server;
a client comprising a program supporting hyperlinking; and
a communication channel connecting said server and client for communicating said continuous media information from said server to said client, said continuous media information being reproduced at least in part at said client during communication of said continuous media information from said server to said client.

2. A system as claimed in claim 1, wherein said network is the Internet.

3. A system as claimed in claim 1, wherein said network comprises at least one of a local area network (LAN), metropolitan area network (MAN) and wide area network (WAN).

4. A system as claimed in claim 1, wherein said program comprises a web browser.

5. A system as claimed in claim 1, wherein said continuous media information comprises a plurality of continuous media information segments and at least one hyperlink corresponding to each segment, thereby enabling presentation of a compilation of continuous media information segments through activation of said hyperlinks.

6. A system as claimed in claim 1, wherein said continuous media information includes at least one hyperlink therein corresponding to static data, so that activation of said hyperlink leads to static text or static image data relating to the subject matter of said continuous media information.

7. A system as claimed in claim 1, wherein said continuous media information includes at least one hyperlink therein corresponding to audio information, so that activation of said hyperlink leads to an audio presentation relating to the subject matter of said continuous media information.

8. A system as claimed in any one of claims 5-7, wherein said hyperlink specifies a start position and an end position of an object in a video image.

9. A system as claimed in any one of claims 5-7, wherein said hyperlink specifies a start frame and position within said start frame where an object appears at a first time in a video stream, and an end frame and end position within said end frame where said object appears at a second time in said video stream.

10. A system as claimed in claim 1, wherein said continuous media information includes at least first and second segments, with said first segment including a link associated with said second segment and said communication channel communicating said second segment in response to said link in said first segment.

11. A system as claimed in claim 10, wherein said first segment is one of audio and video and said second segment is a different one of audio and video.

12. A system as claimed in claim 1, wherein said continuous media information includes at least one of video and audio information and is stored at said server together with meta-information relating to the contents of said video or audio information.

13. A system as claimed in claim 12, wherein said meta-information relates to at least one media-specific characteristic such as encoding scheme specification, encoding parameters or frame access points.

14. A system as claimed in claim 12, wherein said meta-information relates to a hierarchical structure of said continuous media information.

15. A system as claimed in claim 12, wherein said meta-information comprises a description of at least a portion of said continuous media information.

16. A system as claimed in claim 12, wherein said meta-information comprises hyperlink specifications for at least one object within said continuous media information.

17. A system as claimed in claim 1, wherein said server includes a transmit control program controlling at least one characteristic of transmission of said continuous media information by said server in response to a monitored performance characteristic of said client.

18. A system as claimed in claim 17, wherein said monitored performance characteristic is congestion.

19. A system as claimed in claim 1, wherein said server includes a transmit control program controlling at least one characteristic of transmission of said continuous media information by said server when a quality of transmission of said continuous media information changes.

20. A system as claimed in claim 19, wherein said continuous media information includes both video and audio portions and said transmit control program changes a transmission characteristic of only one of said portions in response to monitored quality of transmission.

21. A system as claimed in claim 19, wherein a change in said quality of transmission of said continuous media information includes a change in an amount of loss of said video information.

22. A system as claimed in claim 19, wherein said transmission characteristic is a rate of transmission.

23. A system as claimed in claim 19, wherein said transmit program controller reduces transmission of said continuous media information to said client when a quality of transmission decreases.

24. A system as claimed in claim 19, wherein said transmit control program changes said transmission characteristic when said quality of transmission changes by a predetermined amount within a predetermined time.

25. A system as claimed in claim 19, wherein a change in said quality of transmission of said continuous media information includes a change in an amount of jitter in said video information.

26. A system as claimed in claim 19, wherein a change in said quality of transmission of said video information includes a change in an amount of latency in said video information.

27. A system as claimed in claim 19, further comprising a plurality of clients connected to said server, said transmit control program separately controlling the transmission rate of said server to each of said plurality of clients.

28. A system as claimed in claim 27, wherein said transmit control program separately controls the transmission rates of said continuous media information between said server and each said client in accordance with control information communicated separately between said server and each of said clients.

29. A system as claimed in claim 19, wherein said transmit control program controls the transmission rate of said continuous media information from said server to said client in accordance with control information communicated between said server and said client.

30. A system as claimed in claim 29, wherein said communication channel comprises:
a first channel communicating said control information between said server and said client; and
a second channel transmitting said continuous media information from said server to said client.

31. A system as claimed in claim 30, wherein said first channel employs a first communications protocol.

32. A system as claimed in claim 31, wherein said first communications protocol is Transmission Control Protocol (TCP).

33. A system as claimed in claim 29, wherein said control information includes a play command from said client to said server to play said continuous media information; a stop command from said client to said server to halt transmission of said continuous media information; a rewind command from said client to said server to play said continuous media information in a reverse direction; a fast forward command from said client to said server to cause said server to play said continuous media information at a faster speed; and a quit command from said client to said server to terminate playback of said continuous media information.

34. A system as claimed in claim 19, wherein one of said server and client includes a performance monitor which measures performance of said client and provides a client performance output, said control program causing said server to change a characteristic of transmission of said continuous media information when a quality of transmission of said continuous media information changes by a predetermined amount between consecutive measurements of said performance.

35. A system as claimed in claim 34, wherein said second channel also transmits said output of said performance monitor from said client to said server.

36. A system as claimed in claim 34, wherein said performance monitor further measures performance of said communication channel and provides a channel performance output, said control program causing said server to change its rate of transmission of said continuous media information when said quality of transmission of said video information changes by said predetermined amount between consecutive measurements of said client and channel performance.

37. A system as claimed in claim 36, wherein said control program causes said server to transmit said continuous media information at a slower rate when said predetermined amount is above an engineering threshold.

38. A system as claimed in claim 36, wherein said control program causes said server to transmit said video information at a faster rate when said predetermined amount is below an engineering threshold.

39. A system as claimed in claim 36, wherein said server comprises a logger for recording statistics concerning said client and channel performance.

40. A system as claimed in claim 34, wherein said transmission characteristic is a transmission rate.

41. A system as claimed in claim 19, wherein said control program causes said server to transmit said continuous media information at a slower rate when said predetermined amount is above an engineering threshold.

42. A system as claimed in claim 19, wherein said control program causes said server to transmit said continuous media information at a faster rate when said predetermined amount is below an engineering threshold.

43. A system as claimed in claim 1 or 2, wherein said server comprises:
a main request dispatcher for receiving requests from said client for transmission of said continuous media information;
an admission controller, responsive to said main request dispatcher, for determining whether to service said requests, and advising said main request dispatcher accordingly; and
a continuous media handler for processing requests for continuous media information from said main request dispatcher.

44. A system as claimed in claim 43, wherein said continuous media handler separates said requests for continuous media information into requests for video information and requests for audio information, said server further comprising:
a video handler for processing said requests for video information; and
an audio handler for processing said requests for audio information.

45. A method of transmitting continuous media information over a network from a server to a client, said continuous media information comprising at least one of video information and audio information, said method comprising:
transmitting to said server over a communication channel, from a client comprising a program supporting hyperlinking, a request for transmission of said continuous media information; and
transmitting said continuous media information from said server to said client, said continuous media information being reproduced at least in part at said client during communication of said continuous media information from said server to said client.

46. A method as claimed in claim 45, wherein said step of transmitting said request comprises activating a hyperlink to thereby initiate a stream of continuous media information.

47. A method as claimed in claim 45, wherein said network is the Internet.

48. A method as claimed in claim 45, wherein said program comprises a browser.

49. A method as claimed in claim 45, wherein said continuous media information comprises a plurality of continuous media information segments and at least one hyperlink corresponding to each segment, thereby enabling presentation of a compilation of continuous media information segments through activation of said hyperlinks.

50. A method as claimed in claim 45, wherein said continuous media information includes at least one hyperlink therein corresponding to static data, so that activation of said hyperlink leads to static text or image data relating to the subject matter of said continuous media information.

51. A method as claimed in claim 45, wherein said continuous media information includes at least one hyperlink therein corresponding to audio information, so that activation of said hyperlink leads to an audio presentation relating to the subject matter of said continuous media information.

52. A method as claimed in any one of claims 49-51, wherein said hyperlink specifies a start position and an end position of an object in a video image.

53. A method as claimed in any one of claims 49-51, wherein said hyperlink specifies a start frame and position within said start frame where an object appears at a first time in a video stream, and an end frame and end position within said end frame where said object appears at a second time in said video stream.

54. A method as claimed in claim 49, wherein said continuous media information includes at least one of video and audio information and is stored at said server together with meta-information relating to the contents of said video or audio information.

55. A method as claimed in claim 54, wherein said meta-information relates to at least one media-specific characteristic such as encoding scheme specification, encoding parameters or frame access points.

56. A method as claimed in claim 54, wherein said meta-information relates to a hierarchical structure of said continuous media information.

57. A method as claimed in claim 54, wherein said meta-information comprises a description of at least a portion of said continuous media information.

58. A method as claimed in claim 54, wherein said meta-information comprises hyperlink specifications for at least one object within said continuous media information.

59. A method as claimed in claim 45, further comprising the steps of monitoring a performance characteristic of said client and controlling at least one characteristic of transmission of said continuous media information by said server in accordance with said monitored characteristic.

60. A method as claimed in claim 59, wherein said continuous media information includes both video and audio portions and said controlling step comprises controlling a transmission characteristic of only one of said portions in accordance with said monitored characteristic.

61. A method as claimed in claim 59, wherein said monitored performance characteristic is congestion.

62. A method as claimed in claim 45, further comprising the step of controlling at least one characteristic of transmission of said continuous media information by said server when a quality of transmission of said continuous media information changes by a predetermined amount.

63. A method as claimed in claim 62, wherein said transmission characteristic is a rate of transmission.

64. A method as claimed in claim 62, wherein said controlling step comprises reducing transmission of said continuous media information to said client when a quality of transmission decreases.

65. A method as claimed in claim 62, wherein said controlling step comprises changing said transmission characteristic when said quality of transmission changes by a predetermined amount within a predetermined time.

66. A method as claimed in claim 62, wherein a change in said quality of transmission of said continuous media information includes a change in an amount of loss of said video information.

67. A method as claimed in claim 62, wherein a change in said quality of transmission of said continuous media information includes a change in an amount of jitter in said video information.

68. A method as claimed in claim 62, wherein a change in said quality of transmission of said video information includes a change in an amount of latency in said video information.

69. A method as claimed in claim 62, further comprising a plurality of clients connected to said server, said controlling step comprising separately controlling the transmission rate of said server to each of said plurality of clients.

70. A method as claimed in claim 69, further comprising the step of communicating control information between said server and each of said clients, wherein said controlling step comprises separately controlling the transmission rates of said continuous media information between said server and each said client in accordance with said control information.

71. A method as claimed in claim 62, further comprising the step of communicating control information between said server and said client, said controlling step being responsive to said control information.

72. A method as claimed in claim 71, wherein said communication channel comprises:
a first channel communicating said control information between said server and said client; and
a second channel transmitting said continuous media information from said server to said client.

73. A method as claimed in claim 72, wherein said first channel employs a first communications protocol.

74. A method as claimed in claim 73, wherein said first communications protocol is Transmission Control Protocol (TCP).

75. A method as claimed in claim 71, wherein said control information includes a play command from said client to said server to play said continuous media information; a stop command from said client to said server to halt transmission of said continuous media information; a rewind command from said client to said server to play said continuous media information in a reverse direction; a fast forward command from said client to said server to cause said server to play said continuous media information at a faster speed; and a quit command from said client to said server to terminate playback of said continuous media information.

76. A method as claimed in claim 62, further comprising the step of measuring at one of said server and client the performance of said client and providing a client performance output, said controlling step comprising causing said server to change its rate of transmission of said continuous media information when a quality of transmission of said continuous media information changes by a predetermined amount between consecutive measurements of said performance.

77. A method as claimed in claim 76, wherein said second channel also transmits said output of said performance monitor from said client to said server.

78. A method as claimed in claim 76, further comprising the step of measuring performance of said communication channel and providing a channel performance output, said controlling step causing said server to change its rate of transmission of said continuous media information when said quality of transmission of said continuous media information changes by said predetermined amount between consecutive measurements of said client and channel performance.

79. A method as claimed in claim 78, wherein said controlling step comprises causing said server to transmit said continuous media information at a slower rate when said predetermined amount is above an engineering threshold.

80. A method as claimed in claim 78, wherein said controlling step comprises causing said server to transmit said continuous media information at a faster rate when said predetermined amount is below an engineering threshold.

81. A method as claimed in claim 78, further comprising the step of recording statistics concerning said client and channel performance.

82. A method as claimed in claim 62, further comprising the step of measuring, at one of said server and client, the performance of said client and providing a client performance output, said controlling step comprising causing said server to change its rate of transmission of said continuous media information when a quality of transmission of said continuous media information changes by a predetermined amount between consecutive measurements of said performance.

83. A method as claimed in claim 62, wherein said controlling step comprises causing said server to transmit said continuous media information at a slower rate when said predetermined amount is above an engineering threshold.

84. A method as claimed in claim 62, wherein said controlling step comprises causing said server to transmit said continuous media information at a faster rate when said predetermined amount is below an engineering threshold.

85. A method as claimed in claim 45, wherein said server comprises:
a main request dispatcher for receiving requests from said client for transmission of said continuous media information;
an admission controller, responsive to said main request dispatcher, for determining whether to service said requests, and advising said main request dispatcher accordingly; and
a continuous media handler for processing requests for continuous media information from said main request dispatcher.

86. A method as claimed in claim 85, wherein said continuous media handler separates said requests for continuous media information into requests for video information and requests for audio information, said server further comprising:
a video handler for processing said requests for video information; and
an audio handler for processing said requests for audio information.

87. A method as claimed in claim 45, further comprising the steps of:
detecting congestion in said client and, if there is, advising said server accordingly; and
altering a rate of transmission of said continuous media information from said server to said client based on an outcome of said detecting step.

88. A method as claimed in claim 45, further comprising the step of detecting congestion on said network and, if there is, advising said server accordingly; said altering step being performed based on an outcome of at least one of said client congestion detecting step or said network congestion detecting step.

89. A method as claimed in claim 71, wherein said step of sending control signals is performed over a first channel, and said step of transmitting continuous media information is performed over a second, different channel.

90. A method as claimed in claim 45, wherein communication over said first channel is established before communication over said second channel is established.

91. A method as claimed in claim 45, further comprising the steps of:
transmitting a request from said client to said server for transmission of said continuous media information;
evaluating said request at said server to determine whether said request can be granted; and
if said request can be granted, transmitting a grant from said server to said client.

92. A method as claimed in claim 91, further comprising the steps of:
after said request is evaluated at said server, and it is determined that said request can be granted, establishing communication between said client and said server;
estimating a round trip time (RTT) for travel of data between said server and said client; and
setting an initial transfer rate for transmission of said continuous media information from said server to said client.

93. A method as claimed in claim 92, further comprising the step of, if said request cannot be granted, terminating communication between said server and said client.

94. A method of transmitting continuous media information from a server to a client, comprising:
dividing said continuous media information into segments;
providing at least one hyperlink associated with each segment; and
transmitting a segment from said server in response to activation of an associated hyperlink.

95. A method as claimed in claim 94, further comprising the steps of:
associating at least one keyword with each segment; and
searching said keywords for a desired keyword;
and wherein said transmitting step comprises transmitting a segment to said client upon activation of a hyperlink corresponding to said desired keyword.

96. A system for transmitting real-time continuous media information over a network, said continuous media information comprising video information and audio information, said system comprising:
a server;
a client;
a communication channel between said server and said client for communicating control information between said server and said client, and for transmitting said continuous media information from said server to said client; and
a control program causing said server to change its rate of transmission of said continuous media information when a quality of transmission of said continuous media information changes by a predetermined amount within a predetermined time.

97. A method of transmitting continuous media information over a network from a server to a client, said continuous media information comprising video information and audio information, said method comprising:
transmitting to said server from said client a request for transmission of said continuous media information;
transmitting said continuous media information from said client to said server;
sending control signals from said client to said server to control said transmitting of said continuous media information;
receiving said continuous media information at said client in accordance with said second transmitting step;
detecting congestion in said client and, if there is, advising said server accordingly; and
altering a rate of transmission of said continuous media information from said server to said client based on an outcome of said detecting step.

98. A method of organizing continuous media information, comprising:
dividing said continuous media information into groups of frames; and
for each of said groups of frames, providing at least one keyword corresponding thereto, so that entry of said keyword causes a pointer to be placed at a beginning of said corresponding group of frames.

99. A method as claimed in claim 98, further comprising the step of providing at least one hyperlink in said continuous media information, so that activation of said hyperlink causes a pointer to be placed at a location in said continuous media information corresponding to said hyperlink.

100. A method as claimed in claim 99, further comprising the step of, for each of a plurality of continuous media information, providing at least one hyperlink, so as to enable compilation of a presentation of continuous media information through activation of each said hyperlink.
